(19) United States
(12) Patent Application Publication
(10) Pub. No.: US 2011/0025875 A1
(43) Pub. Date: Feb. 3, 2011

(54) IMAGING APPARATUS, ELECTRONIC INSTRUMENT, IMAGE PROCESSING DEVICE, AND IMAGE PROCESSING METHOD

(75) Inventor: Shinichi IMADE, Iruma-shi (JP)

Correspondence Address: VOLPE AND KOENIG, P.C., UNITED PLAZA, 30 SOUTH 17TH STREET, PHILADELPHIA, PA, 19103, US

(73) Assignee: Olympus Corporation, Tokyo (JP)

(21) Appl. No.: 12/845,145

(22) Filed: Jul. 28, 2010

(30) Foreign Application Priority Data
Aug. 3, 2009 (JP) 2009-180961

(51) Int. Cl. H04N 5/228

(52) U.S. Cl. 348/222.1; 348/E05.031

(57) ABSTRACT

An imaging apparatus includes an imaging optical system that forms an image of an object in an image-pickup element, and a pixel shift control section that causes the image of the object formed in the image-pickup element to be shifted by a shift amount s, and then sampled. A storage section stores a plurality of field images that are obtained when the image-pickup element performs an imaging operation each time the image of the object is shifted by the shift amount s. An image generation section generates a frame image based on the plurality of field images, and sequentially outputs the generated frame image every field.

Japanese Patent Application No. 2009-180961 filed on Aug. 3, 2009, is hereby incorporated by reference in its entirety.

### BACKGROUND

The present invention relates to an imaging apparatus, an electronic instrument, an image processing device, an image processing method, etc.

A camera having a reduced size has been desired for digital cameras, mobile phones, and the like. It is necessary to form a compact imaging unit (imaging system) in order to reduce the size of a camera. However, since the size of the imaging unit is limited by the number of pixels of the image-pickup element, the number of pixels is limited when pursuing a reduction in size of the imaging unit. This makes it difficult to reduce the size of the imaging unit while maintaining a sufficient resolution.

The above problem may be solved by applying a pixel shift method (e.g., JP-A-2006-115074 and JP-A-11-75097). The pixel shift method mechanically shifts the image-pickup element at a pitch smaller than the pixel pitch, acquires an image each time the image-pickup element has been shifted, and synthesizes a plurality of images thus obtained to increase the resolution. However, since the images corresponding to one cycle of the shift operation are synthesized per cycle to generate a frame image, the frame rate necessarily decreases. When increasing the speed of the shift operation in order to increase the frame rate, the sensitivity decreases due to an insufficient exposure time.

JP-A-2009-10615 discloses a method that displays an image on a display device using a pixel shift method to increase the display resolution. JP-A-10-257506 discloses a method that controls the modulation transfer function (MTF) of the optical system by defocus control of the imaging lens, and utilizes the transfer function instead of an optical low-pass filter.

### SUMMARY

According to one aspect of the invention, there is provided an imaging apparatus comprising:

an image-pickup element;

an imaging optical system that forms an image of an object in the image-pickup element;

a pixel shift control section that causes the image of the object formed in the image-pickup element to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to another aspect of the invention, there is provided an imaging apparatus comprising:

a compound imaging unit that includes a plurality of image-pickup elements, and a plurality of imaging optical systems that form an image of an object in the plurality of image-pickup elements;

a pixel shift control section that causes the image of the object formed in each of the plurality of image-pickup elements to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to another aspect of the invention, there is provided an imaging apparatus comprising:

an image-pickup element that includes first to rth (r is a natural number) pixel groups that are formed to sample an image of an object at a pitch of p;

an imaging optical system that forms the image of the object in the image-pickup element;

an imaging control section that controls imaging of the image-pickup element so that an image is sequentially acquired every field using each of the pixel groups;

a storage section that stores a plurality of field images, each of the plurality of field images being obtained by imaging using each of the pixel groups; and

an image generation section that generates a frame image based on the plurality of field images, and sequentially outputs the generated frame image every field.

According to another aspect of the invention, there is provided an electronic instrument comprising one of the above imaging apparatuses.

According to another aspect of the invention, there is provided an image processing device comprising:

a pixel shift control section that causes an image of an object formed in an image-pickup element to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to another aspect of the invention, there is provided an image processing method comprising:

causing an image of an object formed in an image-pickup element to be shifted by a shift amount s, and then sampled;

storing a plurality of field images, each of the plurality of field images being obtained by each of imaging operations, each of imaging operations being performed by the image-pickup element while the image of the object is shifted by the shift amount s and

generating a frame image based on the plurality of field images, and sequentially outputting the generated frame image every field.

### BRIEF DESCRIPTION OF THE DRAWINGS

FIG. 1 shows a basic configuration example of an imaging apparatus according to one embodiment of the invention.

FIG. 2 shows a detailed configuration example of an imaging section.

FIGS. 3A and 3B show basic operation examples according to one embodiment of the invention.

FIG. 4 shows a basic operation example according to one embodiment of the invention.

FIG. 5 shows a detailed configuration example according to one embodiment of the invention.

FIG. 6 shows a specific example of a mode according to one embodiment of the invention.

FIG. 7 shows a frame image synthesis method.

FIG. 8 shows a frame image synthesis method.

FIG. 9 shows an operation example when applying one embodiment of the invention to color imaging.

FIG. 10 shows a detailed configuration example of a lens driver section.

FIG. 11 is a view illustrative of an MTF adjustment using an optical filtering process.

FIG. 12 is a view illustrative of an MTF adjustment using an optical filtering process.

FIG. 13 shows a first modification of an imaging apparatus according to one embodiment of the invention.

FIG. 14 shows a detailed configuration example of the imaging section according to the first modification.

FIGS. 15A and 15B are views illustrative of an operation according to the first modification.

FIG. 16 shows a second modification of the imaging apparatus according to one embodiment of the invention.

FIG. 17 is a view illustrative of an operation according to the second modification during zoom imaging.

FIG. 18 shows a first operation example according to the second modification.

FIG. 19 shows the first operation example according to the second modification.

FIG. 20 shows a second operation example according to the second modification.

FIG. 21 shows the second operation example according to the second modification.

FIG. 22 shows a modification of a compound imaging unit.

FIG. 23 shows an operation example according to a third modification.

FIG. 24 shows an operation example according to the third modification.

FIG. 25 shows a detailed configuration example according to the third modification.

FIG. 26 shows a configuration example of an electronic instrument.

### DESCRIPTION OF EXEMPLARY EMBODIMENTS

Several aspects of the invention may provide an imaging apparatus, an electronic instrument, an image processing device, an image processing method, etc., that enable high-resolution photography.

According to one embodiment of the invention, there is provided an imaging apparatus comprising:

an image-pickup element;

an imaging optical system that forms an image of an object in the image-pickup element;

a pixel shift control section that causes the image of the object formed in the image-pickup element to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to the above embodiment, the image of the object is shifted by the shift amount s, and then sampled. The image-pickup element performs the imaging operation each time the image of the object is shifted by the shift amount s to obtain a field image. A plurality of field images thus obtained are stored. A frame image is generated based on the plurality of field images, and sequentially output every field. This makes it possible to implement high-resolution photography using a pixel shift while preventing a decrease in frame rate.

In the imaging apparatus,

the pixel shift control section may perform a shift operation a plurality of times per cycle, the shift operation shifting the image of the object by the shift amount s; and

the image generation section sequentially may output the generated frame image every field that is shorter than the cycle.

This makes it possible to output the field images of a plurality of field images per cycle. Therefore, the frame rate can be increased as compared with the case of outputting the frame image of one frame per cycle.

The imaging apparatus may further comprise:

an optical filtering section that performs an optical filtering process that adjust an upper limit of a spatial frequency band of the image of the object formed in the image-pickup element to a frequency fm; and

a band-limiting section that band-limits the frame image by a cut-off frequency fc,

“fc≦fm≦1/2s” may be satisfied.

In the imaging apparatus,

the optical filtering section may perform the optical filtering process by focus control.

This makes it possible to adjust the upper limit frequency fm of the spatial frequency band using the optical filtering process. Moreover, a band limit corresponding to the shift amount s can be implemented by satisfying “fm≦1/2s”.

The imaging apparatus may further comprise:

an optical low-pass filter that band-limits the spatial frequency of the image of the object by a cut-off frequency fo; and

an aperture mask, a length of one side of a pixel aperture of the aperture mask being a,

“a≦s≦p” and “fm≦fo” may be satisfied when a pixel pitch of the image-pickup element is p.

This makes it possible to prevent a situation in which an identical pixel is acquired before and after the shift operation by satisfying “a≦s”. Moreover, an image that has a high resolution as compared with the pixel pitch can be acquired by satisfying “s≦p”. The frequency fm can be adjusted within the range of fm≦fo by satisfying “fm≦fo”.

In the imaging apparatus,

the image generation section may generate the frame image by synthesizing a kth field image with (k−(n−1))th to (k−1)th field images (k and n are natural numbers),

the kth field image may be obtained by a current imaging operation performed by the image-pickup element,

the (k−(n−1))th to (k−1)th field images may be obtained by preceding (k−(n−1))th to (k−1)th imaging operations performed by the image-pickup element.

In the imaging apparatus,

the image generation section may generate a pixel value of a pixel of an mth frame image by performing a temporal interpolation process using a pixel value that corresponds to the pixel of a first field image and a pixel value that corresponds to the pixel of an nth field image (m and n are natural numbers),

the pixel value that corresponds to the pixel of the first field image may be obtained by a first imaging operation performed by the image-pickup element before an mth imaging operation,

the pixel value that corresponds to the pixel of the nth field image may be obtained by an nth imaging operation performed by the image-pickup element after the mth imaging operation.

According to the above configuration, a frame image can be generated based on the plurality of field images obtained by imaging, and can be sequentially output every field.

In the imaging apparatus,

the pixel shift control section may perform a shift operation during zoom imaging while reducing the shift amount s.

This makes it possible to compensate for a decrease in resolution during zoom imaging by performing a pixel shift, so that the resolution during zoom imaging can be improved.

According to another embodiment of the invention, there is provided an imaging apparatus comprising:

a compound imaging unit that includes a plurality of image-pickup elements, and a plurality of imaging optical systems that form an image of an object in the plurality of image-pickup elements;

a pixel shift control section that causes the image of the object formed in each of the plurality of image-pickup elements to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to the above embodiment, since the imaging apparatus includes the compound imaging unit, a plurality of field images can be acquired every field, and a frame image can be sequentially output every field based on the field images obtained by imaging. This makes it possible to increase the resolution and the frame rate.

According to another embodiment of the invention, there is provided an imaging apparatus comprising:

an image-pickup element that includes first to rth (r is a natural number) pixel groups that are formed to sample an image of an object at a pitch of p;

an imaging optical system that forms the image of the object in the image-pickup element;

an imaging control section that controls imaging of the image-pickup element so that an image is sequentially acquired every field using each of the pixel groups;

a storage section that stores a plurality of field images, each of the plurality of field images being obtained by imaging using each of the pixel groups; and

an image generation section that generates a frame image based on the plurality of field images, and sequentially outputs the generated frame image every field.

According to the above embodiment, since the field image is sequentially acquired using the first to rth pixel groups, the imaging period of each pixel group can be increased as compared with the field rate. This makes it possible to increase the sensitivity. Moreover, since the frame image is sequentially generated every field, the frame rate can be increased.

According to another embodiment of the invention, there is provided an electronic instrument comprising one of the above imaging apparatuses.

According to another embodiment of the invention, there is provided an image processing device comprising:

a pixel shift control section that causes an image of an object formed in an image-pickup element to be shifted by a shift amount s, and then sampled;

a storage section that stores a plurality of field images, each of the plurality of field images being obtained by each of imaging operations, each of imaging operations being performed by the image-pickup element while the image of the object is shifted by the shift amount s; and

an image generation section that generates a frame image based on the plurality of field images, and sequentially outputs the generated frame image every field.

According to another embodiment of the invention, there is provided an image processing method comprising:

causing an image of an object formed in an image-pickup element to be shifted by a shift amount s, and then sampled;

storing a plurality of field images, each of the plurality of field images being obtained by each of imaging operations, each of imaging operations being performed by the image-pickup element while the image of the object is shifted by the shift amount s and

generating a frame image based on the plurality of field images, and sequentially outputting the generated frame image every field.

Preferred embodiments of the invention are described in detail below. Note that the following embodiments do not in any way limit the scope of the invention defined by the claims laid out herein. Note that all elements of the following embodiments should not necessarily be acquired as essential requirements for the invention.

### 1. Basic Configuration Example

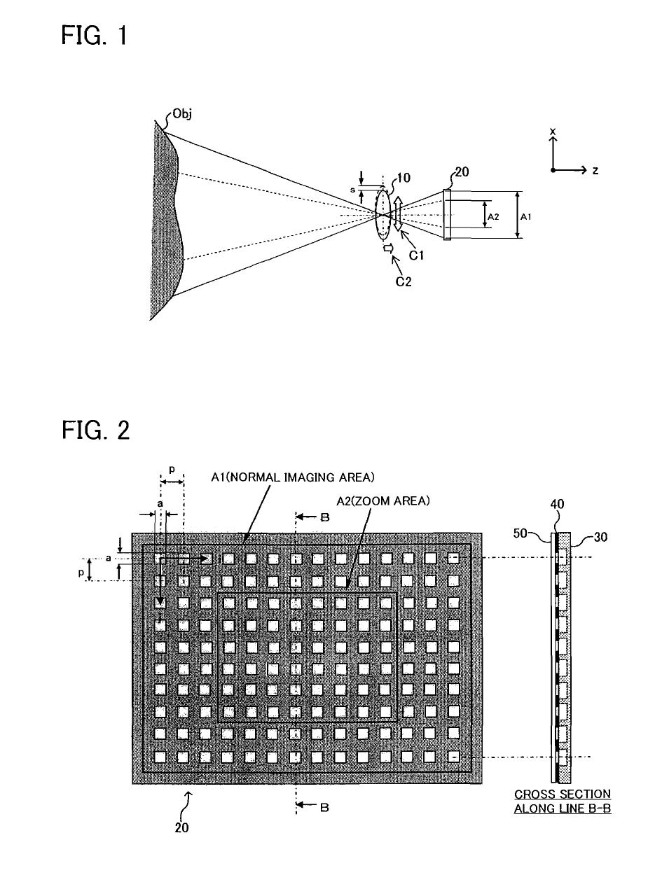

FIG. 1 shows a basic configuration example of an imaging apparatus. The imaging apparatus includes a lens 10 (imaging optical system in a broad sense) and an imaging section 20 (image-pickup element), and implements an increase in resolution by a pixel shift method while preventing a decrease in frame rate.

The lens 10 forms an image of an object Obj in an image plane (light-receiving plane) of the imaging section 20. The lens 10 includes a plurality of lenses, for example. A focus lens is driven in the direction along the optical axis (z-axis) so that the image of the object is brought into focus. As indicated by C1 in FIG. 1, the lens 10 is subjected to pixel shift control by a lens driver section (not shown). Specifically, the lens 10 is shifted (moved) by a shift amount s in the direction along an x-axis (or y-axis) that perpendicularly intersects the optical axis. The image of the object formed in the image plane is also shifted by the shift amount s when the lens 10 is shifted by the shift amount s.

The imaging section 20 acquires the image of the object Obj formed by the lens 10. Specifically, the imaging section 20 performs the imaging operation each time the lens 10 is shifted to acquire a plurality of field images obtained by sampling the image of the object that is shifted by the shift amount s.

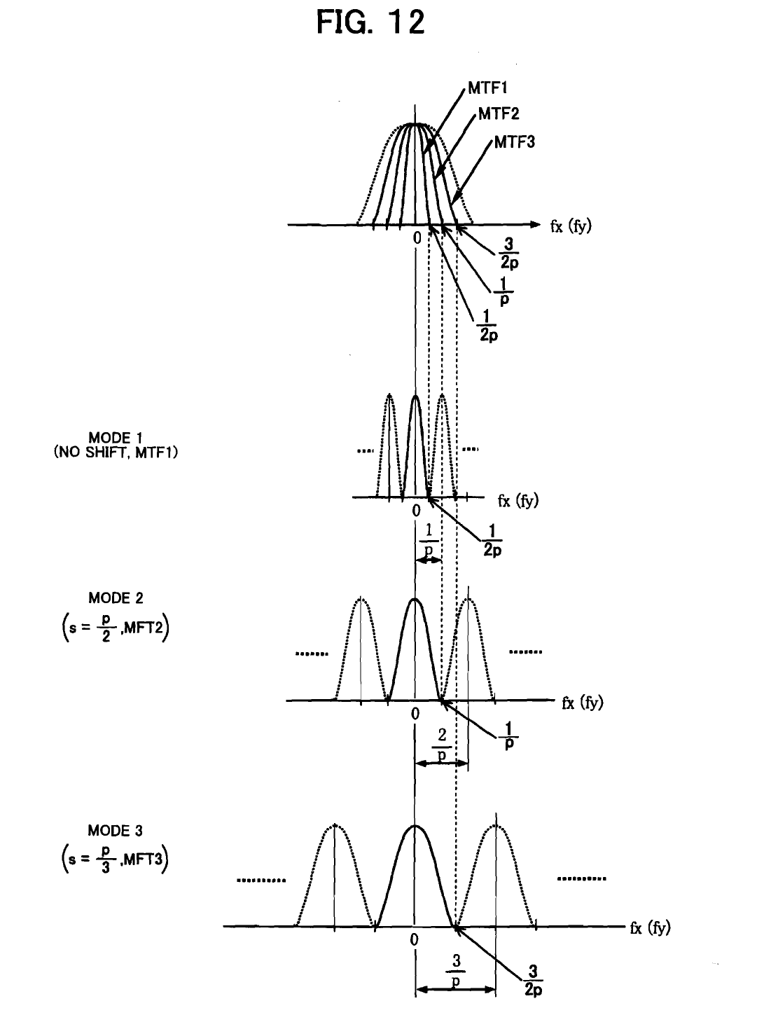

As indicated by C2 in FIG. 1, the image of the object is band-limited (optically filtered) corresponding to the shift amount s. Specifically, the defocus amount is adjusted (defocus control) by focus control so that the modulation transfer function (MTF) (optical transfer function in a broad sense) of the lens 10 is adjusted. The image of the object is band-limited by the spatial frequency characteristics of the MTF thus adjusted. For example, defocus control is performed so that the defocus amount decreases (i.e., the bandwidth of the MTF broadens) as the shift amount s decreases, as described later with reference to FIG. 12. The term “defocus amount” used herein refers to the distance between the focus (focus position or focal point) when the object has been brought into focus and the focus when defocus control has been performed, for example.

In the above configuration example, pixel shift control is performed by shifting the lens 10 by the shift amount s. Note that pixel shift control may be performed by shifting the imaging section 20 by the shift amount s.

FIG. 2 shows a detailed configuration example of the imaging section. The imaging section 20 shown in FIG. 2 includes an image-pickup element 30 (photoelectric conversion element in a broad sense), a pixel aperture mask 40, and an optical low-pass filter 50 (optical filter in a broad sense).

The image-pickup element 30 is implemented by a CCD image sensor or a CMOS image sensor, for example. The image-pickup element 30 acquires the image of the object formed on the light-receiving plane. The pixel aperture mask 40 is provided on the light-receiving plane of the image-pickup element 30, and limits the pixel aperture of the image-pickup element 30. The optical low-pass filter 50 is implemented by a crystal optical filter, for example. The optical low-pass filter 50 limits the spatial frequency band of the image of the object acquired by the image-pickup element 30. The filter 50 has a cut-off frequency fo (e.g., fo=1/2sₘᵢₙ) corresponding to the minimum setting value sₘᵢₙ of the shift amount s.

As shown in FIG. 2, a normal imaging area A1 (first imaging area) and a zoom area A2 (second imaging area) are set in the image plane. The normal imaging area A1 corresponds to the imaging target area of the object Obj during normal imaging, and the zoom area A2 corresponds to the imaging target area of the object Obj during zoom imaging. A frame image is synthesized based on the field image in an area corresponding to the normal imaging area A1 or the zoom area A2. When acquiring an image using the normal imaging area A1, a small image-pickup element having a resolution lower than that of the acquired image may be used by performing pixel shift control. When acquiring an image using the zoom area A2, a decrease in the number of pixels may be compensated for by performing pixel shift control, so that a high-resolution zoom image may be obtained.

When the pixel pitch of the image-pickup element 30 and the mask 40 is referred to as p, and the length of one side of the pixel aperture of the mask 40 is referred to as a, the shift amount s is set to satisfy the relationship “s<p” (e.g., s≦p/2) in order to obtain a resolution higher than that of the image-pickup element 30, and the length a of one side of pixel aperture is set to satisfy the relationship “a≦sₘᵢₙ” (e.g., a≦p/2) so that an identical pixel is acquired before and after the shift operation.

The unit of the shift amount s, the pixel pitch p, and the length of one side of the pixel aperture is μm, for example. The unit of the cut-off frequency fo is μm−1, for example.

### 2. Basic Operation Example

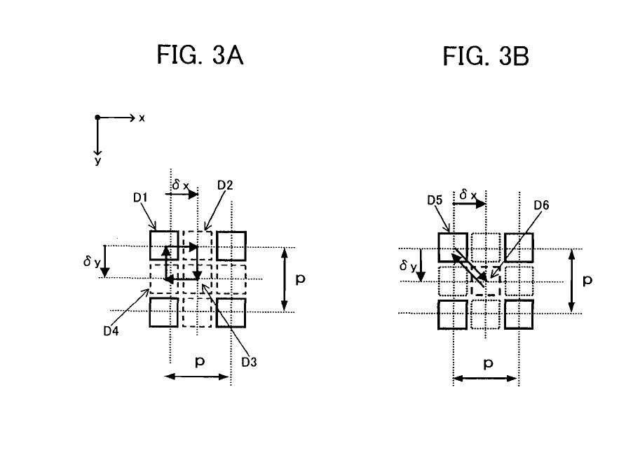

A basic operation example according to this embodiment is described below with reference to FIGS. 3A to 5. FIG. 3A schematically shows an operation example in which the shift operation is performed four times per cycle. The following description is given on the assumption that the image of the object is fixed with respect to the sheet, and a pixel shift occurs with respect to the fixed object image for convenience.

As indicated by D1 in FIG. 3A, the image of the object is acquired at an initial position (basic position). As indicated by D2, a pixel shift by a shift amount δx (e.g., δx=p/2) occurs in the direction along the x-axis (first shift position), and the image of the object is acquired at the first shift position. As indicated by D3, a pixel shift by a shift amount δy (e.g., δy=p/2) occurs in the direction along the y-axis (second shift position), and the image of the object is acquired at the second shift position. As indicated by D4, a pixel shift by a shift amount −δx occurs in the direction along the x-axis (third shift position), and the image of the object is acquired at the third shift position. A pixel shift that returns to the initial position then occurs to complete pixel shift control in the current cycle. Pixel shift control in the next cycle is then performed from the initial position.

FIG. 3B schematically shows an operation example in which the shift operation is performed twice per cycle. As indicated by D5, the image of the object is acquired at an initial position. As indicated by D6, a pixel shift by a shift amount δx and a shift amount δy occurs, and the image of the object is acquired at the shift position. Pixel shift control is performed by performing the above shift operation twice in one cycle.

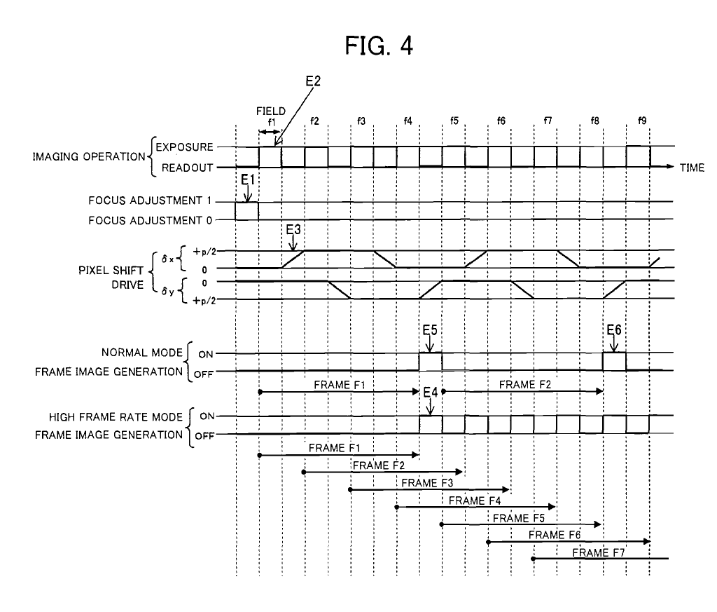

FIG. 4 shows an example of a timing chart according to this embodiment. The term “field image” refers to an image that is acquired when the shift operation has occurred. The term “frame image” refers to an image that is obtained by synthesizing the field images. The frame image is an image of a frame of a moving image or a still image. The following description is given taking an example in which the shift operation is performed four times per cycle.

As indicated by E1 in FIG. 4, focus control is performed before acquiring an image to adjust the focus with respect to the image of the object. As indicated by E2, a field image of a first field f1 is acquired in an exposure period of the first field f1. As indicated by E3, the shift operation to the first shift position is performed in a readout period of the first field f1. A field image of a second field f2 is acquired in an exposure period of the second field f2. The shift operation and the imaging operation are similarly performed every field to acquire a field image of a third field f3, a field image of a fourth field f4, etc.

When the field image of the fourth field f4 has been acquired, the field image of the first field f1, the field image of the second field f2, the field image of the third field f3, and the field image of the fourth field f4 are synthesized to generate a frame image of a first frame F1, as indicated by E4. The frame image of the first frame F1 is output within the field f4. When a field image of a fifth field f5 has been acquired, the field image of the second field f2, the field image of the third field f3, the field image of the fourth field f4, and the field image of the fifth field f5 are synthesized to generate a frame image of a second frame F2. The frame image of the second frame F2 is output within the field f5. The frame image is thus sequentially output every field.

Note that the frame image may be output per cycle of the shift operation. Specifically, the field images of the fields f1 to f4 may be synthesized to generate a frame image of the frame F1 (E5), and the field images of the fields f5 to f8 may be synthesized to generate a frame image of the frame F2 (E6).

### 3. Detailed Configuration Example

FIG. 5 shows a detailed configuration example of the imaging apparatus. The imaging apparatus shown in FIG. 5 includes the image-pickup element 30, an image processing device 100, a lens driver section 200 (optical system driver section), a mode selection section 230, an image recording section 210, and a monitor display section 220. The image processing device 100 includes a system control section 110 (control section), an imaging signal processing section 120, a zoom area selection section 130 (enlarged area selection section), an imaging data readout section 140, a frame buffer memory 150 (storage section), an acquired image generation section 160 (image generation section), a focus control section 170 (optical filtering section), and a pixel shift control section 180 (shift amount control section).

The mode selection section 230 issues instructions about the frame rate and the mode (e.g., zoom) to the image processing device 100. The mode selection section 230 is implemented by a CPU, for example. The mode selection section 230 selects the mode based on information input by a user using an operation section (not shown).

The system control section 110 controls each element of the image processing device 100. Specifically, the system control section 110 controls the imaging timing (exposure timing) and the acquired image readout timing by controlling the image-pickup element 30 and the imaging signal processing section 120. The system control section 110 outputs an area selection signal to the zoom area selection section 130 based on the instructions from the mode selection section 230. The system control section 110 outputs a focus start instruction signal and information about the bandwidth used for the optical filtering process, etc. to the focus control section 170. The system control section 110 outputs information about the shift amount, etc. and a shift operation timing signal to the pixel shift control section 180.

The focus control section 170 receives a control signal from the system control section 110, and performs focus control and the optical filtering process. Specifically, the focus control section 170 adjusts the focus with respect to the image of the object (focusing) by controlling the lens driver section 200. The focus control section 170 adjusts the MTF bandwidth of the optical system by performing defocus control from the focus position (focal point).

The pixel shift control section 180 receives a control signal from the system control section 110, and performs pixel shift control. Specifically, the pixel shift control section 180 outputs a signal that controls the shift amount, the shift position, and the shift timing to the lens driver section 200 to control the shift operation. The pixel shift control section 180 outputs a signal that controls the shift timing to the imaging data readout section 140 to control the imaging data readout timing.

The image-pickup element 30 acquires the field image when the shift operation has occurred. The imaging signal processing section 120 is implemented by an analog front-end circuit (AFE circuit) and a VRAM, for example. The imaging signal processing section 120 process a signal obtained by the imaging operation of the image-pickup element. Specifically, the imaging signal processing section 120 subjects the analog imaging signal to A/D conversion to generate field image data, and stores the generated data in the VRAM.

The zoom area selection section 130 receives the area selection signal from the system control section 110, and issues instructions about the imaging area to the imaging data readout section 140. For example, the zoom area selection section 130 receives the area selection signal that designates the normal imaging area A1 or the zoom area A2 shown in FIG. 2. The zoom area selection section 130 outputs address (coordinate) information about the pixel included in the designated area, etc. as area information.

The imaging data readout section 140 reads the field image (field image data) from the imaging signal processing section 120. Specifically, the imaging data readout section 140 receives the area information from the zoom area selection section 130, and reads the pixel value of the selected area from the VRAM of the imaging signal processing section 120. When the image-pickup element 30 is implemented by a pixel random access sensor (e.g., CMOS image sensor), the imaging data readout section 140 may directly read the pixel value of the image-pickup element 30 via the AFE circuit. In this case, the imaging signal processing section 120 need not include a VRAM.

The frame buffer memory 150 stores the field image that is read by the imaging data readout section 140. Specifically, the frame buffer memory 150 stores a plurality of field images necessary for generating one frame image. The frame buffer memory 150 is implemented by a memory that has an address space corresponding to the frame image, for example. The frame buffer memory 150 stores the pixel value of the field image as the pixel value at the address corresponding to the shift operation.

The acquired image generation section 160 synthesizes the field images stored in the frame buffer memory 150 to generate a frame image (frame image data). The acquired image generation section 160 outputs the generated frame image every field. The acquired image generation section 160 includes a band-limiting section 162 that performs a band-limiting process (low-pass filtering process) on the frame image. The band-limiting section 162 performs the band-limiting process using the cut-off frequency fc that satisfies the relationship “fc≦1/2s”, for example.

The frame image output from the acquired image generation section 160 is recorded by the image recording section 210, for example. Alternatively, the frame image output from the acquired image generation section 160 is displayed on the monitor display section 220. The image recording section 220 is implemented by a flash memory, an optical disk, or a magnetic tape, for example. The monitor display section 220 is implemented by a liquid crystal display device, for example.

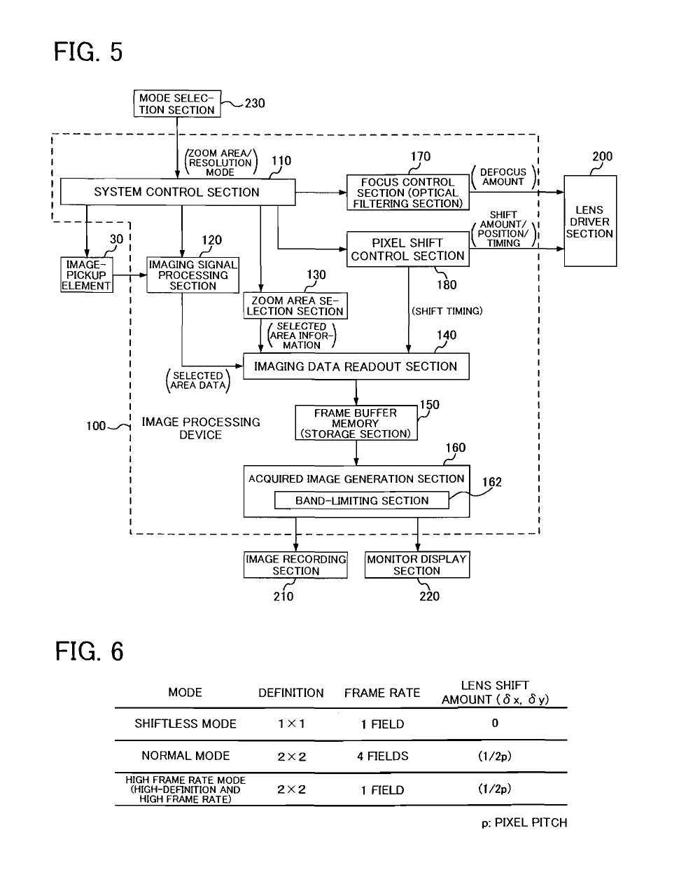

FIG. 6 shows a specific example of the mode according to this embodiment. A shiftless mode is a mode in which pixel shift control is not performed. In the shiftless mode, the pixel shift control section 180 does not perform shift control (lens shift), and the acquired image generation section 160 generates a frame image that has the same resolution as that of the field image. A normal mode is a mode in which pixel shift control is performed in a cycle (four fields) that corresponds to one frame. In the normal mode, the pixel shift control section 180 performs shift control by a shift amount of 1/2p, and the acquired image generation section 160 synthesizes a frame image that has a resolution higher than that of the field image by a factor of 4. A high frame rate mode is a mode in which pixel shift control is performed in a cycle (four fields) that corresponds to four frames. In the high frame rate mode, the pixel shift control section 180 performs shift control by a shift amount of 1/2p. The acquired image generation section 160 synthesizes the field images every field to generate a frame image that has a resolution higher than that of the field image by a factor of 4.

When reducing the number of pixels of the image-pickup element in order to reduce the size of the imaging apparatus, the acquired image has a low resolution. The frame rate decreases when acquiring an image by the pixel shift method in order to increase the resolution. For example, when generating a frame image of one frame after performing the shift operation in one cycle (see E5 in FIG. 4, etc.), the frame rate decreases as compared with the field rate.

According to this embodiment, however, an image of the object is formed in the image-pickup element 30, shifted by the shift amount s, and then sampled. The image-pickup element 30 performs the imaging operation each time the image of the object is shifted by the shift amount s to obtain a field image. A plurality of field images thus obtained are stored. A frame image is generated based on the plurality of field images, and sequentially output every field.

Specifically, the image of the object is shifted by a lens shift (i.e., the first to third shift positions are sequentially set), and is sampled when a shift has occurred by the shift amount s, as described with reference to FIG. 3A, etc. The shift operation and the imaging operation are performed every field (f1, f2, . . . ) (i.e., the imaging operation is performed when a shift has occurred by the shift amount s), as described with reference to FIG. 4, etc. The frame image of the frame F1 is generated based on the field images of the fields f1 to f4, and the frame image of the frame F2 is generated based on the field images of the fields f2 to f5. Specifically, the frame image is generated based on a plurality of field images. The frame image of the frame F1 is output within the field f4, and the frame image of the frame F2 is output within the field f5. Specifically, the frame image is sequentially output every field.

According to this embodiment, an image that has a resolution higher than that of the image-pickup element can be acquired by performing a mechanical pixel shift. This makes it possible to reduce the size of the imaging apparatus while preventing a decrease in resolution. Moreover, since the frame image is sequentially output every field, the frame image can be output at the field rate. This makes it possible to implement high-resolution photography using a pixel shift while preventing a decrease in frame rate.

More specifically, the shift operation is performed a plurality of times per cycle, and the generated frame image is output every field that is shorter than the cycle.

In this embodiment, performing the shift operation four times per cycle corresponds to performing the shift operation a plurality of times per cycle. For example, the cycle may include four fields, and the frame image may be output every field that is shorter than the cycle (four-field period). Alternatively, the frame image may be output every other field that is shorter than the cycle (four-field period).

This makes it possible to output the frame images of a plurality of frames per cycle. In this case, the frame rate can be increased as compared with the case of outputting the frame image of one frame per cycle.

### 4. Frame Image Synthesis Method

### Spatial Interpolation

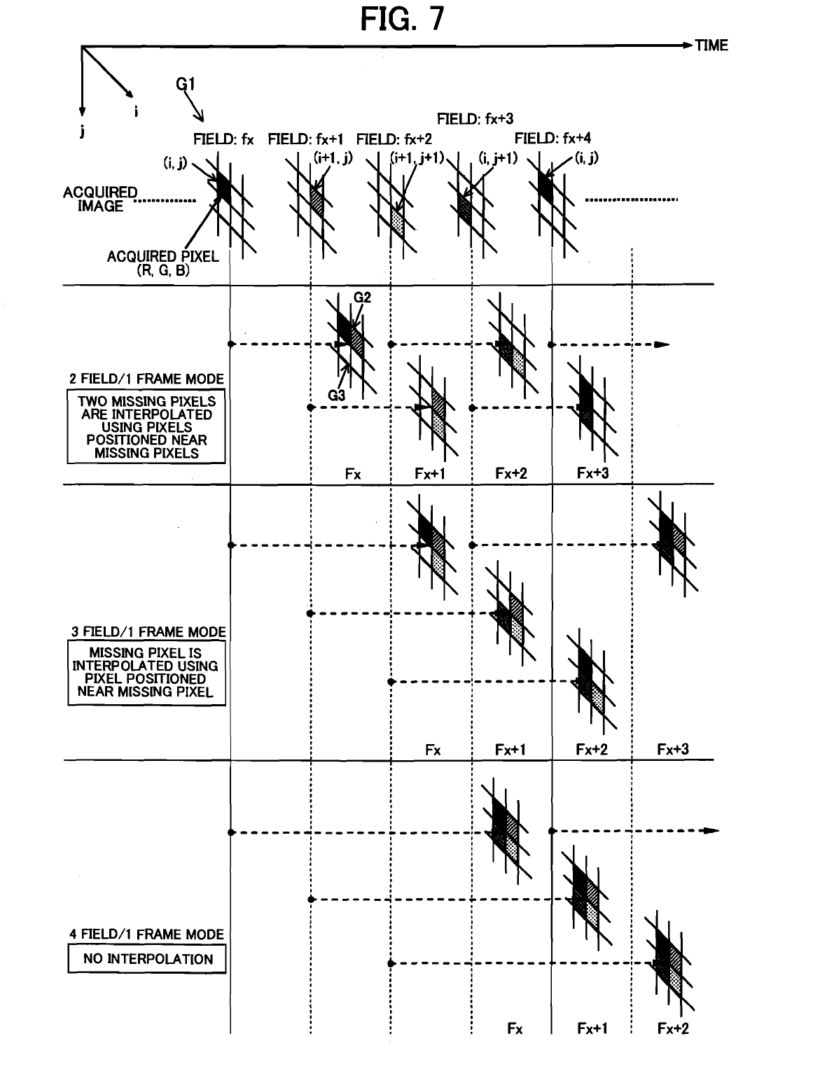

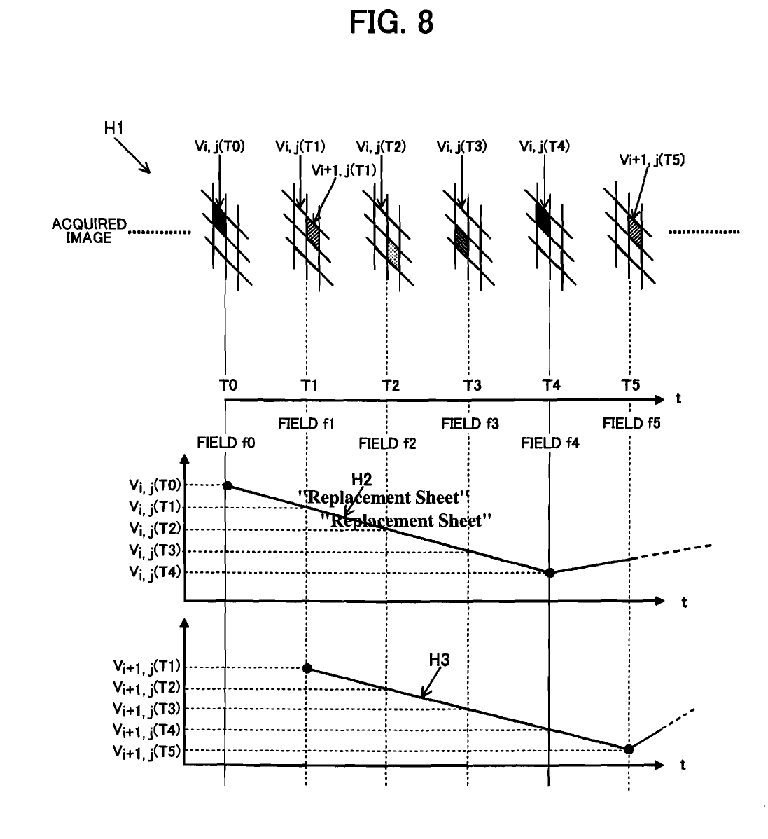

A frame image synthesis method is described below with reference to FIGS. 7 and 8. The following description is given taking an example in which one cycle corresponds to four fields. FIG. 7 is a view illustrative of a synthesis method that spatially interpolates a missing pixel of the frame image. FIG. 7 schematically shows part of the pixel array of the frame image for convenience of description.

As indicated by G1 in FIG. 7, the pixel value at coordinates (i, j) (i and j are odd numbers) of a frame image is obtained from a field image acquired within a field fx (x is a natural number). Likewise, the pixel value at coordinates (i+1, j) is obtained from a field image acquired within a field fx+1, the pixel value at coordinates (i+1, j+1) is obtained from a field image acquired within a field fx+2, and the pixel value at coordinates (i, j+1) is obtained from a field image acquired within a field fx+3. The pixel value at the coordinates (i, j) is again obtained from a field image acquired within a field fx+4. These pixel values indicate the pixel value of an identical pixel of the field image. The coordinates (address) within the frame image are determined corresponding to the pixel shift.

In a mode in which the frame image of one frame is generated based on the field images of two fields (first generation mode), a frame image is generated by synthesizing two field images. For example, the frame image of a frame Fx is generated using the pixel value of the field image of the field fx as the pixel value of the pixel (i, j) and using the pixel value of the field image of the field fx+1 as the pixel value of the pixel (i+1, j), as indicated by G2. As indicated by G3, the pixels (i+1, j+1) and (i, j+1) are missing pixels (i.e., pixels for which the pixel value cannot be directly obtained from the synthesis target field image). The pixel values of the missing pixels are interpolated based on the pixel values of the pixels that are positioned near the missing pixels (e.g., the pixel values of the pixels (i,j) and (i+1, j)).

In a mode in which the frame image of one frame is generated based on the field images of three fields (second generation mode), a frame image is generated by synthesizing three field images. For example, the frame image of the frame Fx is generated using the pixel value of the field image of the field a as the pixel value of the pixel (i,j), using the pixel value of the field image of the field fx+1 as the pixel value of the pixel (i+1, j), and using the pixel value of the field image of the field fx+2 as the pixel value of the pixel (i+1, j+1). The pixel value of the missing pixel (i, j+1) is interpolated based on the pixel value of the pixel that is positioned near the missing pixel.

In a mode in which the frame image of one frame is generated based on the field images of four fields (third generation mode), a frame image is generated by synthesizing four field images. For example, the frame image of the frame Fx is generated using the pixel value of the field image of the field a as the pixel value of the pixel (i,j), using the pixel value of the field image of the field fx+1 as the pixel value of the pixel (i+1, j), using the pixel value of the field image of the field fx+2 as the pixel value of the pixel (i+1, j+1), and using the pixel value of the field image of the field fx+3 as the pixel value of the pixel (i, j+1). In the third generation mode, a missing pixel does not occur since the field images corresponding to one cycle are used. Therefore, the interpolation process is not performed.

A frame image may thus be generated by synthesizing a kth field image obtained by the current imaging operation with (k−(n−1))th to (k−1)th field images obtained by the preceding (k−(n−1))th to (k−1)th imaging operations (k and n are natural numbers).

In FIG. 7, the field image of the field fx+3 corresponds to the kth (e.g., k=x+3) field image obtained by the current imaging operation, for example. The field image of the field fx corresponds to the (k−(n−1))th (e.g., n=4) field image obtained by the preceding (k−(n−1))th imaging operation, the field image of the field fx+1 corresponds to the (k−(n−2))th field image obtained by the preceding (k−(n−2))th imaging operation, and the field image of the field fx+2 corresponds to the (k−1)th field image obtained by the preceding (k−1)th imaging operation.

Therefore, a frame image can be generated based on a plurality of field images, and the frame image thus generated can be sequentially output every field.

A frame image may be generated based on the field images of fields fewer than the number of fields of one cycle. For example, when the number of fields of one cycle is four, a frame image may be generated based on the field images of two fields (n=2) or three fields (n=3).

This makes it possible to reduce the number of fields necessary for synthesizing a frame image. Therefore, a clear image can be acquired even when photographing a moving object or the like.

### 5. Frame Image Synthesis Method

### Temporal Interpolation

FIG. 8 is a view illustrative of a synthesis method that temporally interpolates a missing pixel of the frame image. FIG. 8 schematically shows part of the pixel array of the frame image in the same manner as FIG. 7. Note that times T0 to T5 shown in FIG. 8 indicate the imaging timings of the field images of the fields f0 to f5 or the time series of the field image data.

As indicated by H1 in FIG. 8, pixel values Vi,j(T0) and Vi,j(T4) at the coordinates (i, j) of the frame image are obtained from the pixel values of the field images of the fields f0 and f4. The pixel values other than the pixel value at the coordinates (i,j) are acquired in the fields f1 to f3. Specifically, pixel values Vi,j(T1) to Vi,j(T3) are not directly obtained by the imaging operation.

As indicated by H2, the pixel values Vi,j(T1) to Vi,j(T3) are obtained by performing a temporal interpolation process using the pixel values Vi,j(T0) and Vi,j(T4). For example, the temporal interpolation process is performed using the following expression (1).

Vi,j(T1)=Vi,j(T0)−1/4·{Vi,j(T0)−Vi,j(T4)},

Vi,j(T2)=Vi,j(T0)−2/4·{Vi,j(T0)−Vi,j(T4)},

Vi,j(T3)=Vi,j(T0)−3/4·{Vi,j(T0)−Vi,j(T4)} (1)

As indicated by H3, the pixel values Vi,j(T2) to Vi,j(T4) of the missing pixel at the coordinates (i+1, j) are obtained by performing the temporal interpolation process using the pixel values Vi,j(T1) and Vi,j(T5) obtained in the fields f1 and f5. The pixel values of the missing pixels at the coordinates (i+1, j+1) and (i, j+1) are similarly obtained by performing the temporal interpolation process.

The pixel value of a pixel of an mth frame image may thus be generated by performing the temporal interpolation process using a pixel value that corresponds to the pixel of a first field image obtained by a first imaging operation performed before the mth imaging operation and a pixel value that corresponds to the pixel of an nth field image obtained by an nth imaging operation performed after the mth imaging operation.

In FIG. 8, the imaging operation performed within the field f1 corresponds to the mth imaging operation, the imaging operation performed within the field f0 corresponds to the first imaging operation, and the imaging operation performed within the field f4 corresponds to the nth imaging operation, for example. The pixel value Vi,j(T1) corresponds to the pixel value of the pixel of the mth frame image, the pixel value Vi,j(T0) corresponds to the pixel value that corresponds to the pixel of the first field image, and the pixel value Vi,j(T4) corresponds to the pixel value that corresponds to the pixel of the nth field image.

Therefore, a frame image can be generated based on a plurality of field images, and the frame image thus generated can be sequentially output every field. The movement of the object can be interpolated by performing the temporal interpolation process so that a smooth moving image can be obtained.

### 6. Color Imaging

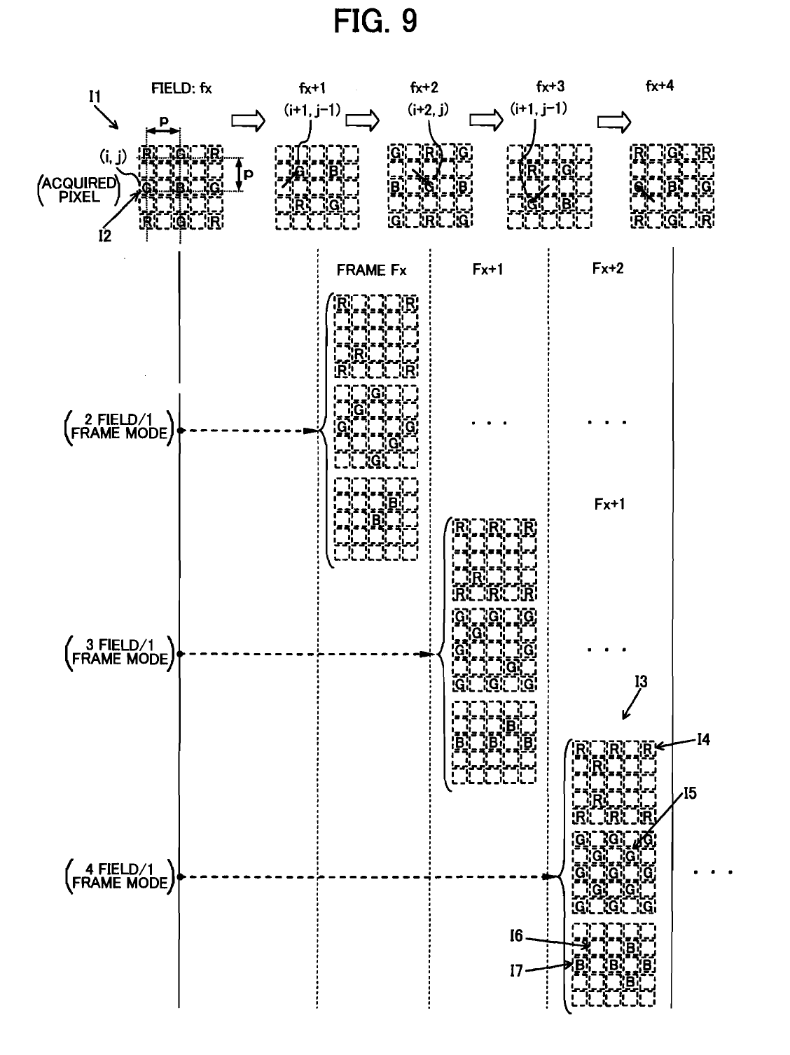

FIG. 9 shows an operation example when applying this embodiment to color imaging. FIG. 9 shows an example in which an R (red), G (green), B (blue) image is acquired using a single-chip image-pickup element having a Bayer array. FIG. 9 shows some of the pixels of the frame image. The pixels of the corresponding field image are schematically indicated using characters R, and B. The frame image of each frame is illustrated using an R image, a G image, and a B image for convenience (e.g., I3 described later).

As indicated by I1 in FIG. 9, the shift operation is performed every field, and an RGB field image that corresponds to the Bayer array is acquired. The following description is given taking a G pixel indicated by I2 as an example. As indicated by I2, the pixel value at the coordinates (i, j) of the frame image is obtained within the field fx from the pixel value of the G pixel. The pixel value at the coordinates (i+1, j−1) of the frame image is obtained within the field fx+1, the pixel value at the coordinates (i+2, j) of the frame image is obtained within the field fx+2, and the pixel value at the coordinates (i+1, j+1) of the frame image is obtained within the field fx+3.

The coordinates of the frame image correspond to the pixel shift position. Specifically, the pixel value at the coordinates (i,j) is obtained within the field fx by the imaging operation at the initial position of the shift operation. The pixel value at the coordinates (i+1, j−1) is obtained within the field fx+1 by the imaging operation at the first shift position (i.e., the lens has been shifted by the shift amount (+p/2, −p/2) (=(δx, δy))), the pixel value at the coordinates (i+2, j) is obtained within the field fx+2 by the imaging operation at the second shift position (i.e., the lens has been shifted by the shift amount (+p, 0) (=(δx, δy))), and the pixel value at the coordinates (i+1, j+1) is obtained within the field fx+3 by the imaging operation at the third shift position (i.e., the lens has been shifted by the shift amount (+p/2, +p/2) (=(δx, δy))). Note that p is the pixel pitch of the image-pickup element.

In the mode in which the frame image of one frame is generated based on the field images of four fields, the field images of the fields fx to fx+3 are synthesized to generate the frame image of the frame Fx, as indicated by I3. In the frame image of the frame Fx the pixel indicated by I4 has the R pixel value and the G pixel value, and the pixel indicated by I5 has the G pixel value and the B pixel value, for example. The pixel values of the pixel indicated by I4 are obtained from the field images of the fields fx and fx+2, and the pixel values of the pixel indicated by I5 are obtained from the field images of the fields fx+1 and fx+3. The B pixel value of the pixel indicated by I6 is not directly obtained from the field image. The pixel value of such a missing pixel is obtained by an interpolation process using the pixel value of the pixel indicated by I7 that is positioned near the missing pixel (i.e., a pixel for which the B pixel value is directly obtained from the field image), for example. The pixel value of the missing pixel is interpolated for each color, and a frame image in which each pixel has RGB pixel values is synthesized.

In the mode in which the frame image of one frame is generated based on the field images of two fields, the field images of the fields fx and fx+1 are synthesized to generate the frame image of the frame Fx. In the mode in which the frame image of one frame is generated based on the field images of three fields, the field images of the fields fx to fx+2 are synthesized to generate the frame image of the frame Fx. The interpolation process is similarly performed on the missing pixel in each mode to generate an RGB frame image.

### 7. Lens Driver Section

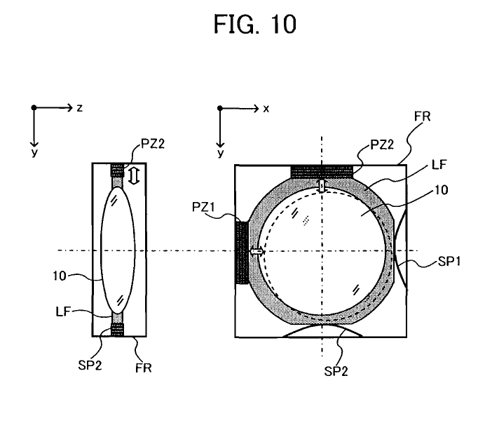

FIG. 10 shows a detailed configuration example of the lens driver section. The lens driver section includes a frame FR (camera cone or housing), a lens frame LF (lens-holding frame), the lens 10, piezoelectric elements PZ1 and PZ2 (actuators), and flat springs SP1 and SP2 (springs or elastic members).

The lens 10 is secured on the lens frame LF. The piezoelectric elements PZ1 and PZ2 and the flat springs SP1 and SP2 are provided between the lens frame LF and the frame FR. The lens 10 is provided between the piezoelectric element PZ1 and the flat spring SP1 and between the piezoelectric element PZ2 and the flat spring SP2. The piezoelectric element PZ1, the lens 10, and the flat spring SP1 are disposed in the direction along the x-axis, and the piezoelectric element PZ2, the lens 10, and the flat spring SP2 are disposed in the direction along the y-axis.

The lens 10 is shifted by causing the piezoelectric elements PZ1 and PZ2 to expand and contract. Specifically, a shift operation by the shift amount +δx along the x-axis direction is performed by causing the piezoelectric element PZ1 to expand by +δx. A shift operation by the shift amount +δy along the y-axis direction is performed by causing the piezoelectric element PZ2 to expand by +δy.

### 8. Optical Filtering Process

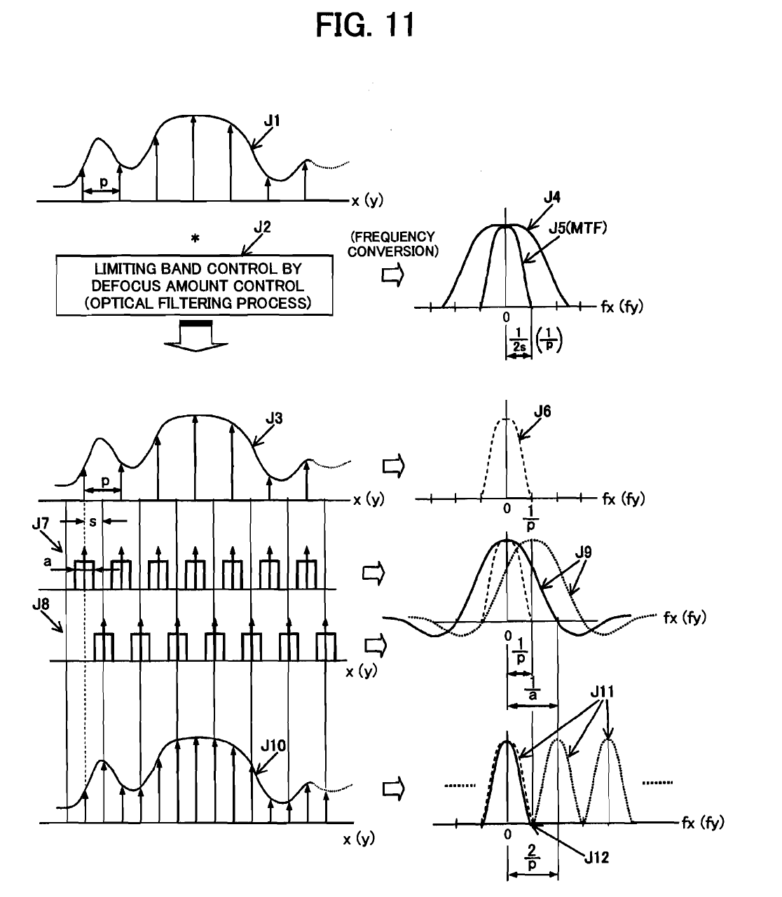

An MTF adjustment using the optical filtering process is described below with reference to FIGS. 11 and 12. FIG. 11 is a view illustrative of the spatial frequency characteristics of pixel shift imaging. FIG. 11 shows an example in which the shift amount s is p/2, and the pixel aperture a is p/2.

The spatial distribution of the brightness of the object is indicated by J1 in FIG. 11. The spatial distribution is band-limited by the optical filtering process (J2). The band-limited image is acquired by the image-pickup element (J3).

Specifically, the frequency distribution of the brightness of the object (J4) is band-limited by the MTF (i.e., the frequency characteristics of the optical system) (J5). The MTF band (cut-off frequency) is adjusted to 1/2s (=1/p) by the optical filtering process corresponding to the shift amount s (=p/2). The band-limited frequency distribution image is acquired by the image-pickup element (J6).

J7 indicates the pixel aperture array of the image-pickup element, and J8 indicates the pixel aperture array when shifted by the shift amount s. A field image that is obtained by sampling the image of the object at the pixel aperture a and the pixel pitch p is obtained by the imaging operation at each shift position. The pixel aperture has a frequency distribution in which a sine function that crosses zero at 1/a repeats in cycles of 1/p. Therefore, the frequency distribution of each field image is expressed by the product of the distributions indicated by J6 and J9 (i.e., repeats in a cycle of 1/p).

A frame image obtained by synthesizing the field images corresponds to an image that is obtained by sampling the image of the object at the pixel aperture a and the pixel pitch p/2 (=s) (J10). Therefore, the frame image has a frequency distribution in which the product of the distribution indicated by J6 and the sine function of the pixel aperture repeats in cycles of 2/p (=1/s). In this case, folding noise due to sampling is prevented by band-limiting the distribution to 1/p using the MTF (J12).

FIG. 12 shows a specific example of the MTF adjustment. FIG. 12 shows an example in which the mode can be selected from a shiftless mode, a mode in which the shift amount s is p/2, or a mode in which the shift amount s is p/3.

As shown in FIG. 12, the MTF of the optical system is adjusted to MTF1 where the band is 1/2p, MTF2 where the band is 1/p, or MTF3 where the band is 3/2p. The defocus amount decreases (i.e., the object is brought into focus) in order from MTF1 to MTF3.

In a first mode (shiftless mode), the image of the object is sampled at the pixel pitch p. In the first mode, MTF1 is selected corresponding to the sampling pitch (p), and the image of the object is band-limited by 1/2p. In a second mode, the image of the object is sampled at a pitch s of p/2. In the second mode, MTF2 is selected corresponding to the sampling pitch s (=p/2), and the image of the object is band-limited by 1/2s (=1/p). In a third mode, the image of the object is sampled at a pitch s of p/3. In the third mode, MTF3 is selected corresponding to the sampling pitch s (=p/3), and the image of the object is band-limited by 1/2s (=3/2p).

Note that the band 3/2p of MTF3 may be implemented by adjusting the MTF using focus control, or may be implemented by the cut-off frequency fo of the optical low-pass filter (e.g., filter 50 shown in FIG. 2) without performing focus control.

The optical filtering process may thus be performed so that the upper limit of the spatial frequency band of the image of the object is adjusted to a frequency fm. As described with reference to FIG. 5, etc., the band-limiting section may band-limit the frame image by the cut-off frequency fc, and these parameters may satisfy the relationship “fc≦fm≦1/2s”.

In FIG. 12, the bands 1/2p, 1/p, and 3/2p of MTF1 to MTF3 correspond to the frequency fm. The optical filtering process is performed by adjusting the MTF of the optical system to MTF1, MTF2, or MTF3, and band-limiting the image of the object by the band corresponding to the shift amount s. The relationship “fm≦1/2s” is satisfied by adjusting the frequency fm to 1/2p, 1/p, or 3/2p corresponding to the shift amount s (=p (no shift), p/2, or p/3). Although FIG. 12 shows an example in which the frequency fm is 1/2s, the frequency fm may be less than 1/2s (fm≦1/2s).

This makes it possible to band-limit the image of the object corresponding to the shift amount s by performing the optical filtering process. Specifically, folding noise can be prevented while ensuring an imaging band corresponding to the shift amount s by band-limiting the image of the object within the range of fm≦1/2s.

The optical filtering process may be performed by focus control. The upper limit frequency fm of the MTF band can be adjusted by adjusting the defocus amount by focus control.

### 9. First Modification

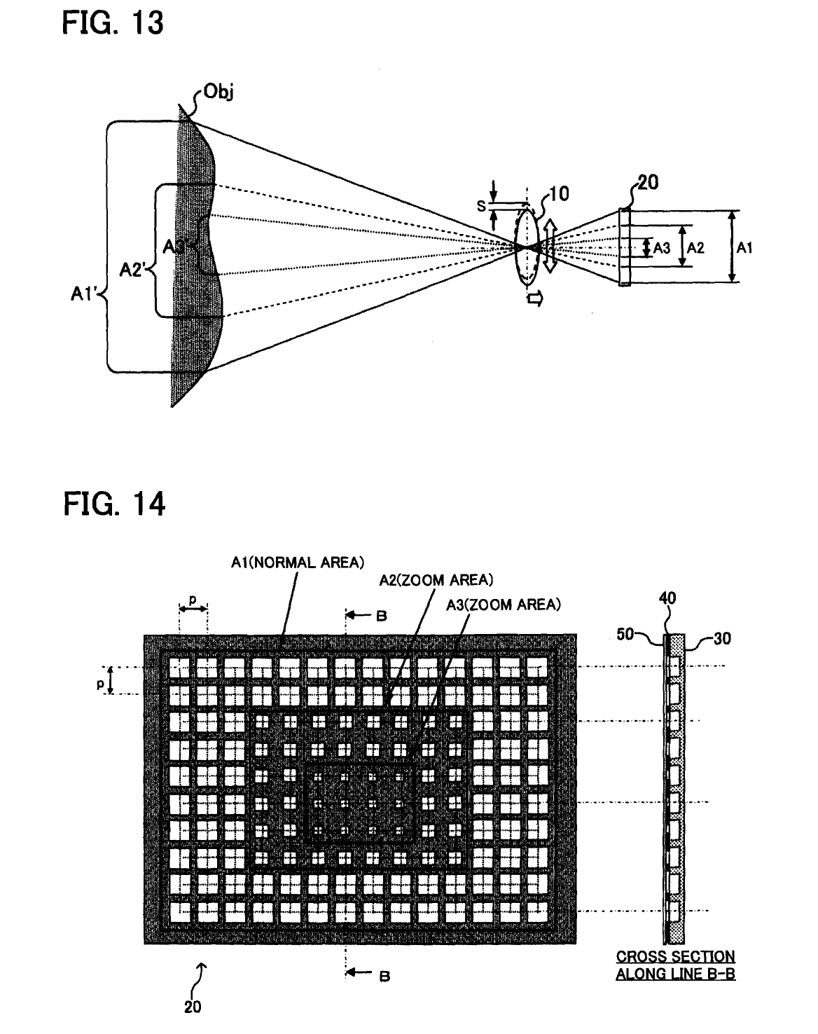

FIG. 13 shows a first modification of the imaging apparatus. The imaging apparatus shown in FIG. 13 includes a lens 10 and an imaging section 20 (image-pickup element), and adjusts the shift amount s corresponding to the zoom magnification to compensate for a deterioration in resolution due to zoom. Note that the same elements as the elements described with reference to FIG. 1, etc. are indicated by the same reference symbols. Description of these elements is appropriately omitted.

A normal imaging area A1, a first zoom area A2, and a second zoom area A3 are set in the image plane of the imaging section 20. An image of an imaging target area A1′ of an object Obj is formed in the normal imaging area A1, an image of an imaging target area A2′ of the object Obj is formed in the first zoom area A2, and an image of an imaging target area A3′ of the object Obj is formed in the second zoom area A3. A frame image is synthesized based on the field images of an area corresponding to the normal imaging area A1 during normal imaging (no zoom). A frame image is synthesized based on the field images of an area corresponding to the first zoom area A2 or the second zoom area A3 during zoom imaging.

The shift amount s is set corresponding to each of the areas A1, A2, and A3. The lens 10 is subjected to pixel shift control by the shift amount s that is set corresponding to each of the areas A1, A2, and A3. The defocus amount of the lens 10 is controlled corresponding to the shift amount s, and the upper limit frequency fm of the MTF is adjusted.

FIG. 14 shows a detailed configuration example of the imaging section according to the first modification. The imaging section 20 includes an image-pickup element 30, a pixel aperture mask 40, and an optical low-pass filter 50.

The pixel aperture mask 40 has different pixel apertures in the areas A1, A2, and A3. Specifically, the pixel apertures that are included in the area A1 and are not included in the area A2, the pixel apertures that are included in the area A2 and are not included in the area A3, and the pixel apertures that are included in the area A3 differ from one another. The length of one side of the pixel apertures decreases as the number of pixels included in the area decreases. Specifically, the length of one side of the pixel apertures decreases as the zoom magnification increases.

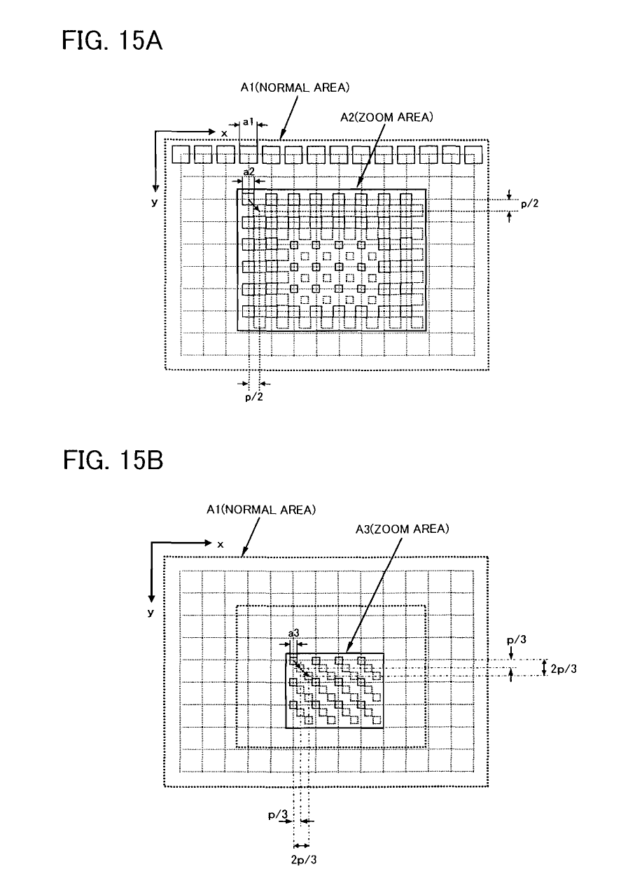

The details are described below with reference to FIGS. 15A and 15B. FIGS. 15A and 15B show some of the pixel apertures of the mask 40 for convenience.

As shown in FIG. 15A, the shift operation is performed by the shift amount s=p/2 when acquiring an image using the area A2. In this case, the length a2 of one side of the pixel apertures in the area A2 is equal to or smaller than p/2 (a2≦p/2). As shown in FIG. 15B, the shift operation is performed by the shift amount s=p/3 when acquiring an image using the area A3. In this case, the length a3 of one side of the pixel apertures in the area A3 is equal to or smaller than p/3 (a3≦p/3) and is smaller than a2 (a3<a2). The pixel shift operation is not performed when acquiring an image using the area A1. In this case, the length a1 of one side of the pixel apertures in the area A1 is equal to or smaller than p (a1≦p) and is larger than a2 (a2<a1).

The shift operation may thus be performed during zoom imaging while reducing the shift amount s. For example, when the shift amount s is p when using the normal imaging area A1, the shift amount s may be p/2 or p/3 (<p) when using the zoom area A2 or A3, respectively.

This makes it possible to compensate for a decrease in the number of pixels due to digital zoom by utilizing a pixel shift during zoom imaging. For example, when the number of pixels in the zoom area is ¼th of the number of pixels in the normal imaging area during 2× digital zoom imaging, the resolution increases by a factor of 4 by performing the shift operation by the shift amount s=p/2, so that a resolution equal to that achieved by normal imaging can be implemented.

The pixel apertures in the zoom area may be smaller than the pixel apertures in the normal area. For example, the length of one side of the pixel apertures in the zoom area may be set to be equal to or smaller than the shift amount s.

This makes it possible to prevent a situation in which an identical pixel is acquired before and after a pixel shift, even if the shift amount s is reduced during zoom imaging. Moreover, the imaging sensitivity can be increased during shiftless normal imaging by setting the pixel apertures in the normal area to be larger than the pixel apertures in the zoom area.

The sensitivity may be corrected corresponding to the imaging area. For example, the sensitivity may be corrected by multiplying the pixel value of each pixel that has a pixel aperture length of a1, a2, or a3 by a coefficient that corresponds to each pixel aperture.

### 10. Second Modification

### Compound System

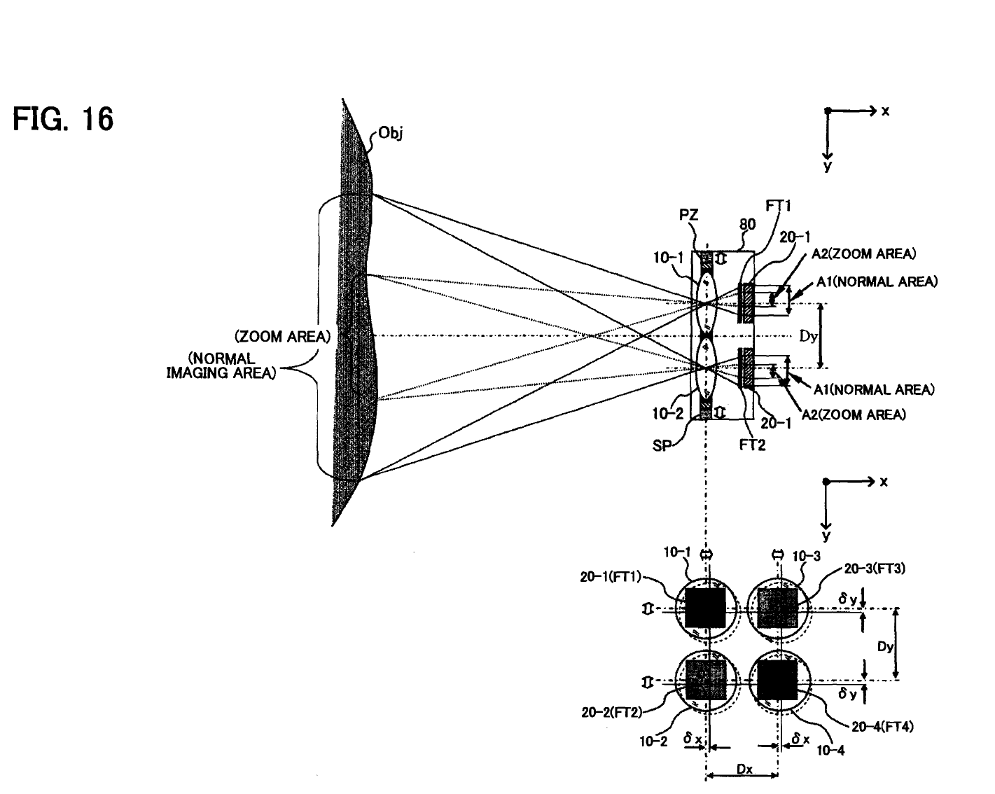

FIG. 16 shows a second modification of the imaging apparatus according to this embodiment. The imaging apparatus includes a compound imaging unit 80, and acquires a color image by the pixel shift method using a plurality of image-pickup elements provided with a color filter. The compound imaging unit 80 includes first to fourth lenses 10-1 to 10-4 (a plurality of imaging optical systems), first to fourth imaging sections 20-1 to 20-4 (a plurality of image-pickup elements), first to fourth color filters FT1 to FT4, a piezoelectric element PZ, and a flat spring SP.

The lenses 10-1 to 10-4 form an image of an object Obj in the imaging sections 20-1 to 20-4, respectively. The image planes of the imaging sections 20-1 to 20-4 are respectively provided with the color filters FT1 to FT4. The color filters FT1, FT2, FT3, and FT4 are R (red), G1 (green), G2 (green), and B (blue) monochromatic filters, respectively. These filters are disposed to form a Bayer array when viewed along the optical axis (z-axis).

The lenses 10-1 to 10-4 are shifted by utilizing the piezoelectric element PZ and the flat spring SP. Specifically, the lenses 10-1 to 10-4 are shifted by a shift amount Sx in the direction along an x-axis, and shifted by a shift amount Sy in the direction along a y-axis. The lenses 10-1 to 10-4 may be simultaneously shifted in an identical direction, or may be shifted in different directions. FIG. 16 shows the piezoelectric element and the flat spring that are used to shift the lenses 10-1 to 10-4 in the y-axis direction. The compound imaging unit 80 also includes a piezoelectric element and a flat spring (not shown) that are used to shift the lenses 10-1 to 10-4 in the x-axis direction. The piezoelectric element and the flat spring may be provided for each lens.

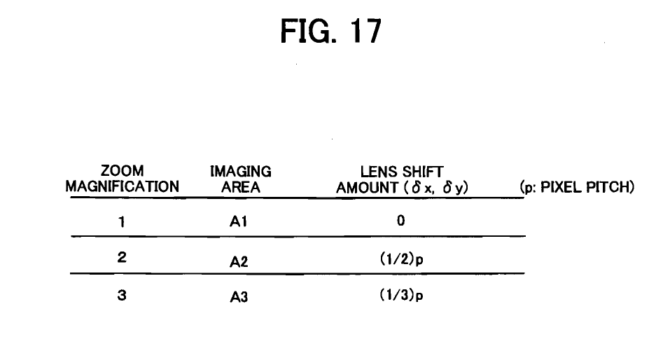

A first operation example according to the second modification is described below with reference to FIGS. 17 to 19. FIG. 17 shows an operation example during zoom imaging.

As shown in FIG. 17, the zoom magnification is set to 1, 2, or 3, for example. In a mode in which the zoom magnification is 1, a normal area A1 is set as the imaging area, and a lens shift does not occur. Specifically, the shift amount (δ×, δy) is set to (0, 0). In a mode in which the zoom magnification is 2, a zoom area A2 is set as the imaging area, and the shift amount (δx, δy) is set to (p/2, p/2). In a mode in which the zoom magnification is 3, a zoom area A3 is set as the imaging area, and the shift amount (δx, δy) is set to (p/3, p/3).

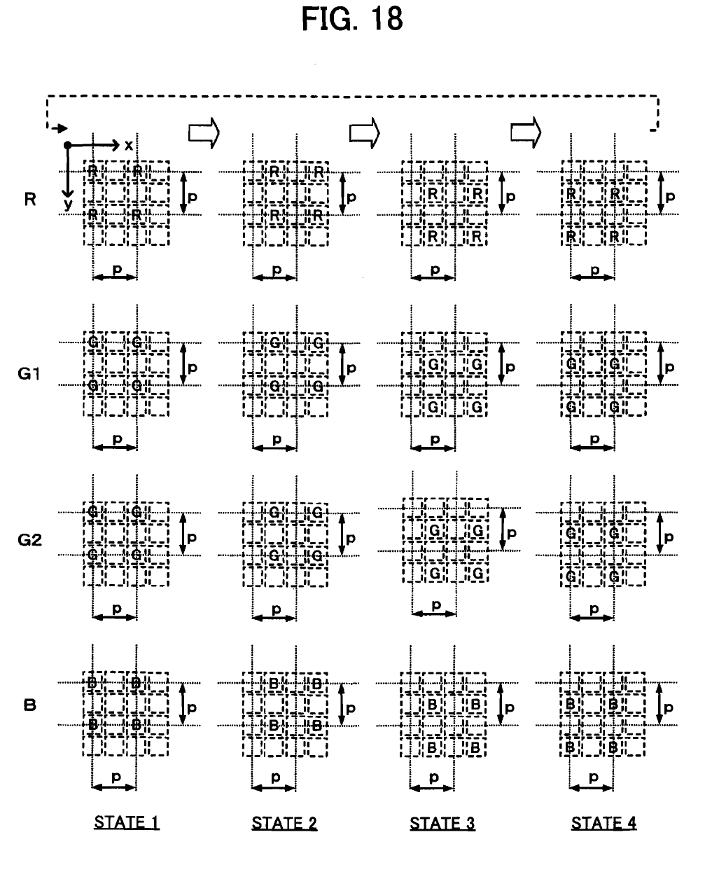

FIG. 18 shows a first shift operation example according to the second modification. In the first shift operation example, the shift operation is performed in the same manner as in FIG. 3A. Specifically, a shift to a first shift position (state 2) occurs from an initial position (state 1) by the shift amount (δx, δy)=(p/2, 0). A shift to a second shift position (state 3) occurs from the first shift position by the shift amount (δx, δy)=(0, p/2). A shift to a third shift position (state 4) occurs from the second shift position by the shift amount (δx, δy)=(−p/2, 0). A shift to the initial position then occurs from the third shift position by the shift amount (δx, δy)=(0, −p/2). The image of the object is acquired at each position. The lenses 10-1 to 10-4 are similarly shifted corresponding to each color (R, G1, G2, and B).

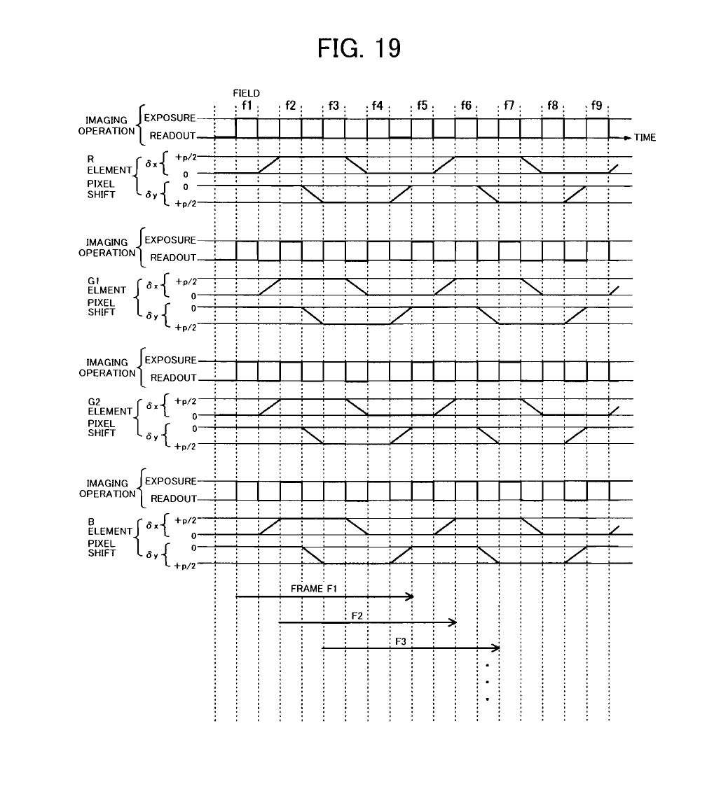

FIG. 19 shows a first timing chart example according to the second modification. As shown in FIG. 19, the shift operation described with reference to FIG. 18 is performed every field. Specifically, the shift operation is performed over four fields as one cycle. A frame image is synthesized based on the field images of four fields, and output every field. For example, the frame image of a frame F1 is synthesized based on the field images of fields f1 to f4, and output within the field f4. The frame image of a frame F2 is synthesized based on the field images of the fields f2 to f5, and output within the field f5.

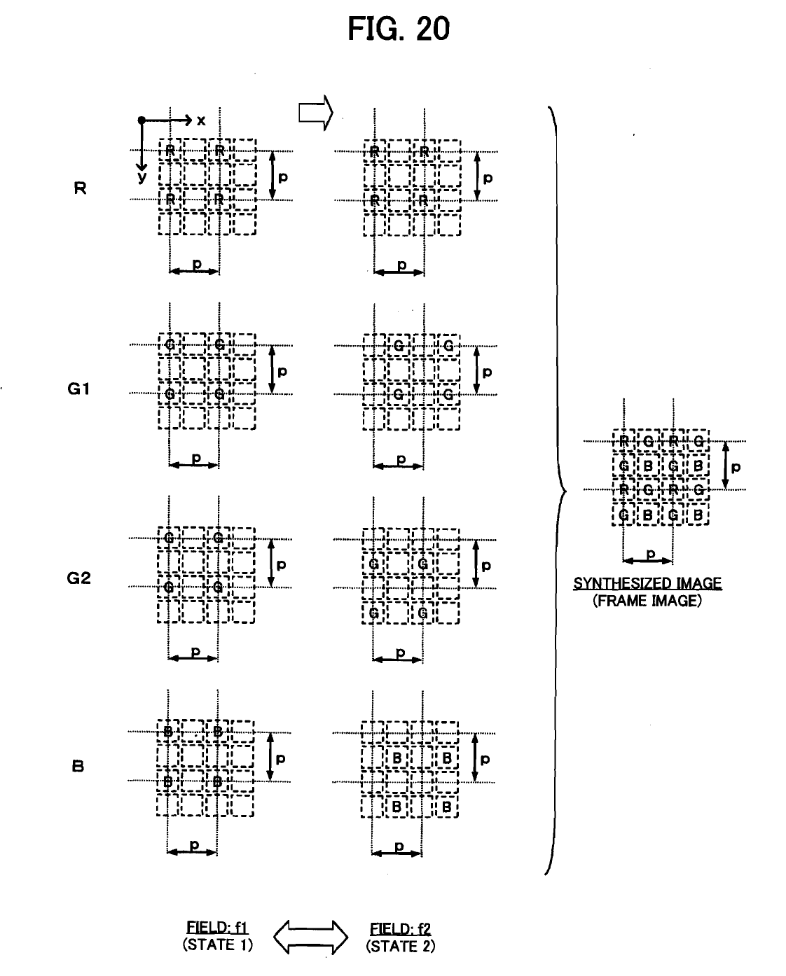

FIG. 20 shows a second shift operation example according to the second modification. In the second shift operation example, a different shift operation is performed corresponding to each color. Specifically, the R, G1, G2, and B lenses are set at the initial position (state 1), and shifted to different positions. More specifically, the R, G1, G2, and B lenses are shifted by the shift amount (δx, δy)=(0, 0), (p/2, 0), (0, p/2), or (p/2, p/2), respectively (shift position (state 2)). A field image is acquired at the shift position. The R, G1, G2, and B field images obtained at the shift position are synthesized to generate a frame image. In this case, the pixel value of each pixel of the frame image that is directly obtained from the field image is the pixel value of one color (i.e., R, G; or B). The pixel value of the missing pixel is interpolated using the pixel value of the pixel is positioned near the missing pixel so that a frame image in which each pixel has RGB pixel values is generated.

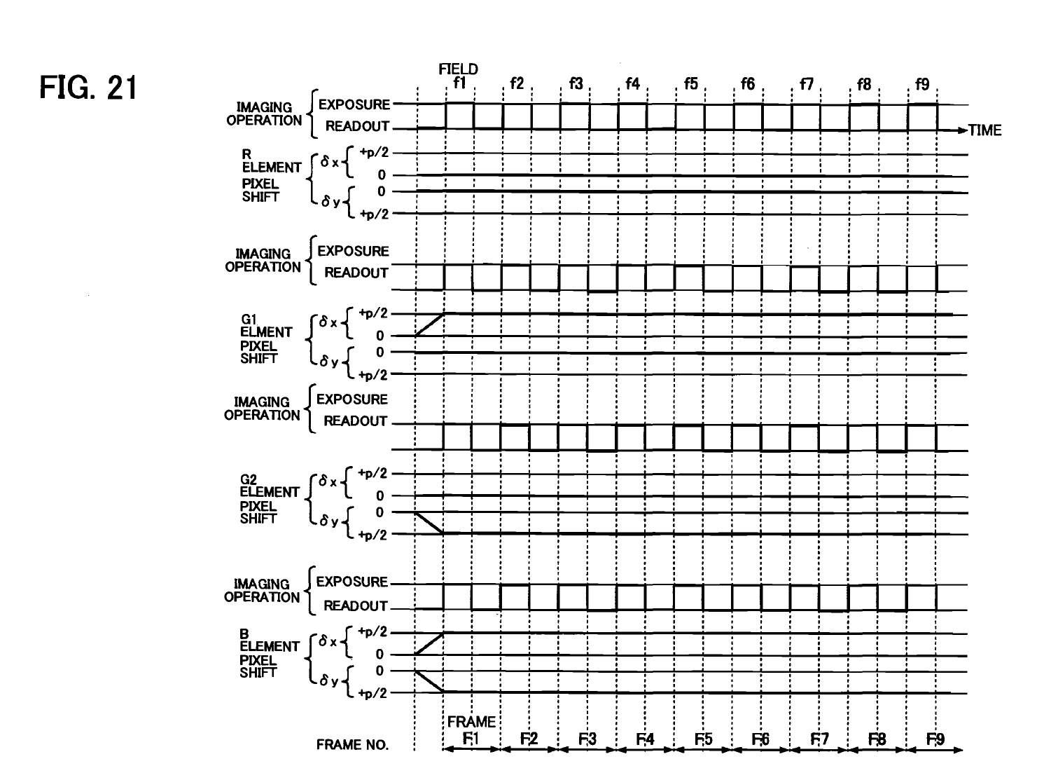

FIG. 21 shows a second timing chart example according to the second modification. As shown in FIG. 21, the shift operation is not performed at the shift position every field. The image of the object is acquired every field, and the field image of each color thus obtained is synthesized to generate a frame image. The frame image thus generated is output every field. For example, the field images are acquired within the field f1. The frame image of the frame F1 is generated based on the field images acquired within the field f1, and output within the field f1.

The lenses may be alternately set at the initial position and the shift position described with reference to FIG. 20. The field image may be acquired at each position, and the frame image may be output every field.

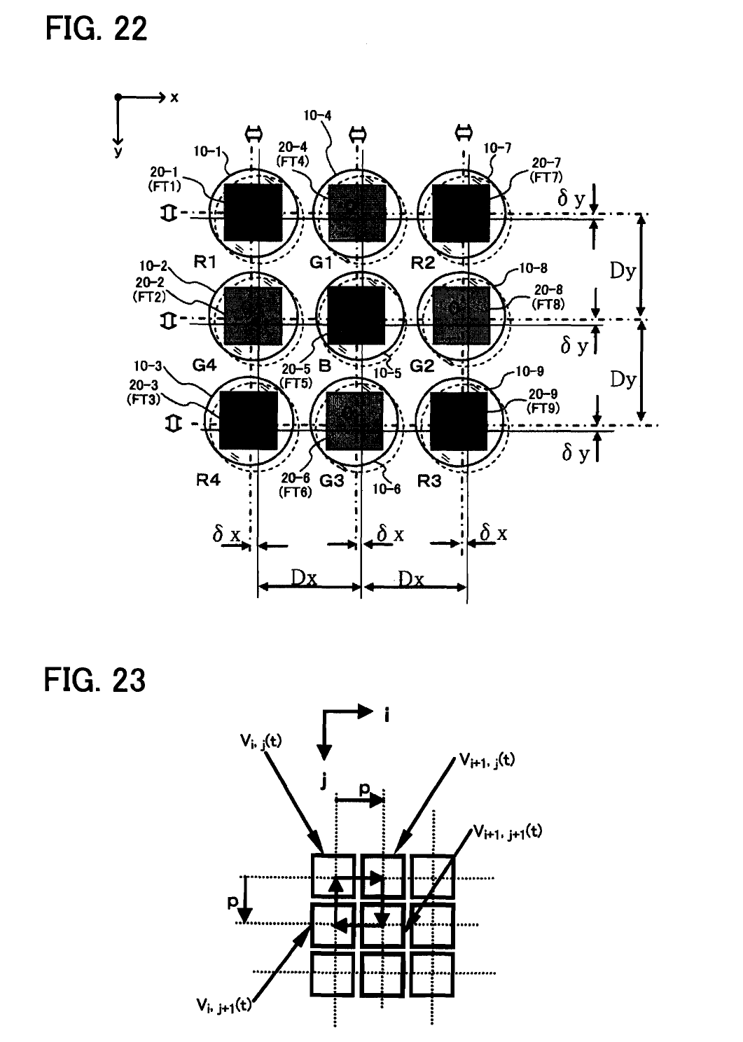

FIG. 22 shows a modification of the compound imaging unit. The compound imaging unit shown in FIG. 22 includes first to ninth lenses 10-1 to 10-9, first to ninth imaging sections 20-1 to 20-9, and first to ninth color filters FT1 to FT9. The compound imaging unit performs a pixel shift by the shift amount s=p/3 during 3× zoom imaging to obtain a color image.

The color filters FT1, FT7, FT9, and FT3 are R1, R2, R3, and R4 (red) monochromatic filters, respectively. The color filters FT4, FT8, FT6, and FT2 are G1, G2, G3, and G4 (green) monochromatic filters, respectively. The color filter FT5 is a B (blue) monochromatic filter. The lenses 10-1 to 10-9 are shifted to different positions. For example, the lenses 10-1 to 10-9 are shifted by the shift amount (δx, δy)=(0, 0), (0, p/3), (0, 2p/3), (p/3, 0), (p/3, p/3), (p/3, 2p/3), (2p/3, 0), (2p/3, p/3), (2p/3, 2p/3), respectively (shift position).

As described above, the imaging apparatus according to this embodiment may include a compound imaging unit, and the compound imaging unit may include a plurality of image-pickup elements, and a plurality of imaging optical systems that form an image of an object in the plurality of image-pickup elements.

This makes it possible to acquire a plurality of field images within one field, and generate a frame image based on the plurality of field images. For example, a field image of each color (RGB) can be acquired within one field by providing a plurality of monochromatic imaging units, and an RGB frame image can be generated by synthesizing the field images.

The shift operation may be similarly performed corresponding to each color (RGB), as described with reference to FIG. 18, etc., and a frame image may be generated based on the field images of four fields.

In this case, a frame image is synthesized based on the field images obtained within one cycle corresponding to each color. This makes it possible to implement high-resolution imaging.

A different shift operation may be performed corresponding to each color (RGB), as described with reference to FIG. 20, etc., and a frame image may be generated based on the field images of one field.

In this case, a frame image is obtained based on the field images of one field. This makes it possible to image a moving object, etc., at high speed.

### 11. Third Modification

### Shift Readout

An imaging apparatus according to a third modification includes a lens (imaging optical system), an image-pickup element, and an image processing device. The imaging apparatus implements the imaging operation of the image-pickup element (each pixel) while making a phase shift without performing a mechanical pixel shift.

FIG. 23 shows an operation example according to the third modification. FIG. 23 shows part of the pixel array of the image-pickup element. The horizontal pixel pitch and the vertical pixel pitch are set to p. A reference pixel position is indicated by (i, j), a pixel position that is situated on the right of the reference pixel position is indicated by (i+1, j), a pixel position that is diagonally adjacent to the reference pixel position is indicated by (i+1, j+), and a pixel position that is situated under the reference pixel position is indicated by (i, j+1) (i is the address in the horizontal direction, and j is the address in the vertical direction). The pixel values of these pixels are referred to as Vi,j, Vi+1,j, Vi+1,j+1, and Vi,j+1, respectively. All of the pixels are actual pixels, differing from the above configuration example. Specifically, the pixels shown in FIG. 23 are not obtained by a pixel shift. The acquisition timings of the pixel values Vi,j, Vi+1,j, Vi+1,j+1, and Vi,j+1 are sequentially shifted by a unit period.

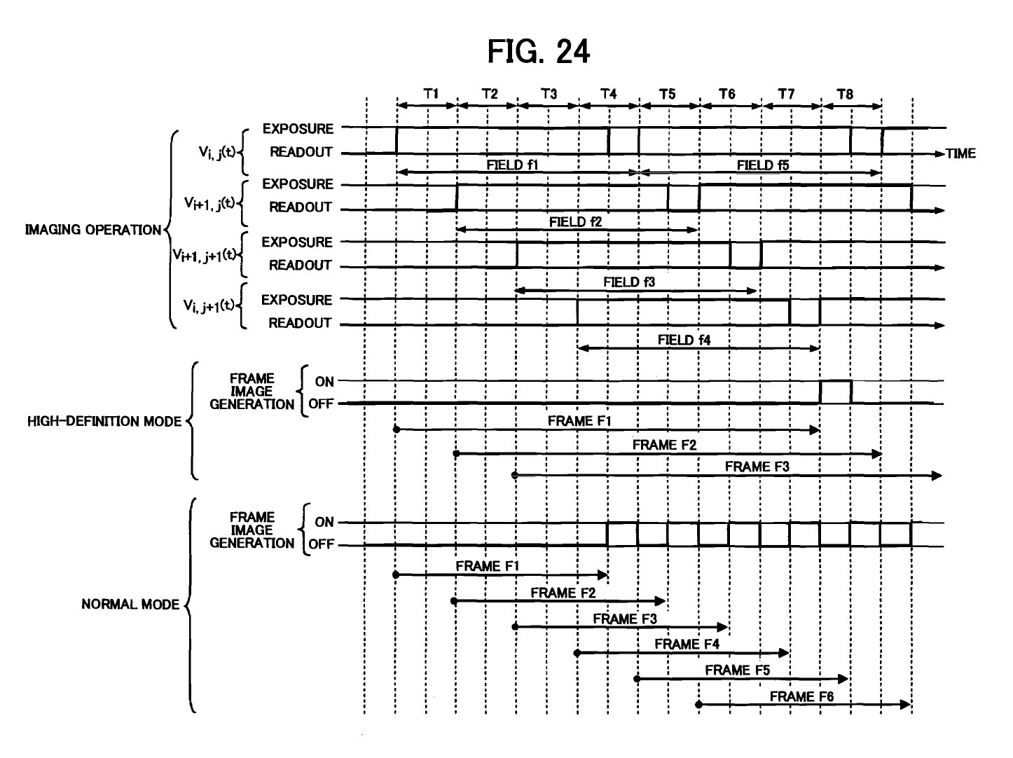

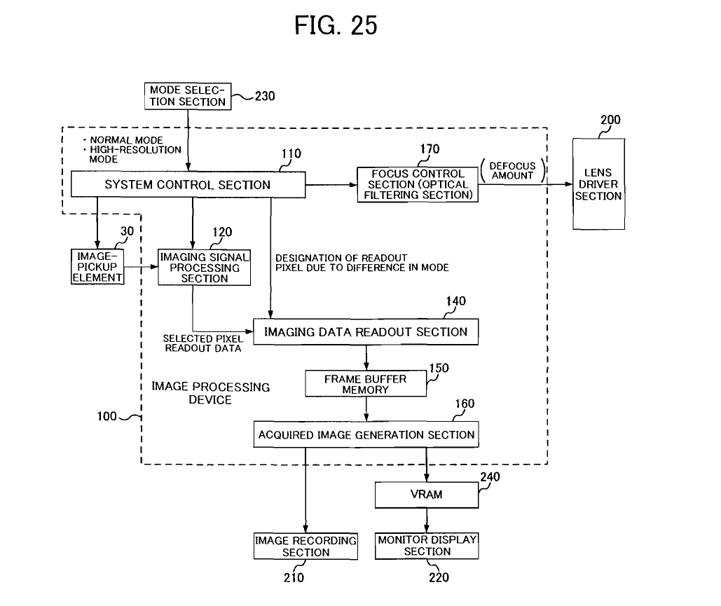

FIG. 24 shows a timing chart example according to the third modification. In FIG. 24, the pixel value readout timing and the frame image generation timing are illustrated along a time axis. The pixel value readout timing occurs every field (f1, f2, . . . ). Specifically, image data that includes a set of the pixel values Vi,j corresponds to one field image, and image data that includes a set of the pixel values Vi+1,j, Vi+1,j+1, or Vi,j+1 corresponds to the remaining three field images. Specifically, four field images that differ in pixel set are used as basic images.

The field image is generated every four unit periods (unit times). For example, when the unit periods are referred to as T1 to T7, exposure and readout are sequentially performed so that the field image of the field f1 is generated within the periods T1 to T4. Likewise, the field image of the field f2 is generated within the periods T2 to T5, the field image of the field f3 is generated within the periods T3 to T6, and the field image of the field f4 is generated within the periods T4 to T7. Specifically, exposure and readout of the adjacent field images are shifted by the unit period. As described above, the pixels of the image-pickup element are divided into four groups, and readout of the readout target pixel is shifted instead of performing a mechanical pixel shift. In FIG. 24, the readout period is set to be half of the unit period. Note that the exposure period and the readout period may be determined taking account of the characteristics of the image-pickup element.

The following high-definition mode and normal mode may be used as the frame image generation mode. In the high-definition mode, an image is formed using all of the pixels of the image-pickup element. In the high-definition mode, a frame image is sequentially generated using the current field image and the preceding three field images among consecutive field images. For example, the field images of the fields f1 to f4 are stored, and are synthesized when the readout period of the field f4 has expired. A frame image using all of the pixels is generated as the frame image of the frame F1. Likewise, the field images of the fields f2 to f5 are synthesized when the readout period of the field f5 has expired to generate the frame image of the frame F2. The above operation is sequentially repeated to generate a moving image. The above image generation process is referred to as the high-definition mode since an image is generated using all of the pixels.

In the normal mode, the field image is directly used as the frame image. Specifically, the frame image of the frame F1 is generated when the readout period of the field f1 has expired. Likewise, the frame image of the frame F2, F3, or F4 is generated when the readout period of the field f2, f3, or f4 has expired. In the normal mode, the number of available pixel values is ¼th of the number of pixels of the image-pickup element. Therefore, the missing pixel value is generated by the interpolation process described with reference to FIGS. 7 and 8, etc. Alternatively, an image that has a resolution that is ¼th of the resolution of a normal frame image may be generated in the normal mode. Specifically, the field image may be converted using a low-pass filter so that four pixels correspond to one pixel to obtain a frame image.

An image-pickup element normally has characteristics in which the pixel value readout period increases as the number of pixels increases. This makes it difficult to achieve a high frame rate while reading the pixel values of all of the pixels.

According to this embodiment, the image-pickup element has first to rth pixel groups (r is a natural number (e.g., r=4)) that are formed so that the image of the object is sampled at intervals of the pitch p. The image of the object is sequentially acquired every field using each pixel group. A plurality of field images obtained using each pixel group are stored, and a frame image is sequentially generated every field based on the plurality of field images.

According to this embodiment, the field image can be generated using the pixel values read from ¼ of the pixels. This makes it possible to reduce the number of pixels from which the pixel values are read simultaneously, so that the frame rate can be increased. According to this embodiment, the exposure period of each pixel is about four times the frame rate. For example, the first pixel group (i, j) can be continuously exposed during the readout periods T5 to T8 of other pixel groups. This makes it possible to implement imaging that is advantageous for sensitivity as compared with a normal imaging method in which the exposure period corresponds to the frame rate.

However, the resolution of the field image becomes ¼th of the resolution of the image-pickup element.

According to this embodiment, however, the exposure timing and the readout timing differ between each pixel group, and the frame image is synthesized using the preceding images and the current image. This makes it possible to ensure a sufficient resolution without causing a deterioration in frame rate.

For example, when acquiring and recording the field imaging data in the normal mode at a high-vision resolution and a frame rate of 30 frames per second, it is possible to generate an ultra-high-definition image that has a resolution four times the high-vision resolution since the imaging data has been obtained while shifting the readout pixel. Moreover, the ultra-high-definition image can be generated without causing a decrease in frame rate.

FIG. 25 is a functional block diagram showing a detailed configuration example according to the third modification. The imaging apparatus includes an image-pickup element 30, an image processing device 100, a lens driver section 200, a mode selection section 230, an image recording section 210, a monitor display section 220, and a VRAM 240. The image processing device 100 includes a system control section 110 (imaging control section), an imaging signal processing section 120, an imaging data readout section 140, a frame buffer memory 150 (storage section), an acquired image generation section 160 (image generation section), and a focus control section 170. Note that the same elements as the elements described with reference to FIG. 5, etc. are indicated by the same reference symbols. Description of these elements is appropriately omitted.

The mode selection section 230 selects the normal mode or the high-definition mode. The system control section 110 outputs a pixel address signal to the imaging data readout section 140 based on the mode selected by the mode selection section 230. The system control section 110 outputs operation instructions to the image-pickup element 30 and the imaging signal processing section 120 to enable the imaging operation of the image-pickup element 30.

The imaging signal processing section 120 processes a signal from the image-pickup element 30, and outputs a pixel value. The imaging signal processing section 120 sequentially outputs only the pixel value of the pixel indicated by the imaging data readout section 140. This makes it possible to increase the readout speed (reduce the readout period). The read pixel value is stored in the frame buffer memory 150 (frame buffer) corresponding to each field image data via the imaging data readout part 140. The acquired image generation section 160 reads the field image data stored in the frame buffer memory 150. The acquired image generation section 160 sequentially generates a frame image based on the field image read from the frame buffer memory 150. When generating a frame image, a missing pixel is interpolated in the normal mode. The frame image thus generated is stored in the image recording section 210. The frame image is also temporarily stored in the VRAM 240, and the display image data is input to and displayed on the monitor display section 220.

The focus control section 170 controls the defocus amount as described with reference to FIG. 5, etc., and optically performs a band-limiting process using the pixel pitch p (or the pixel pitch 2p of each pixel group). When sequentially generating a frame image in which the pixel value of the missing pixel is added by the interpolation process, the band-limiting process may use the upper limit band so that a folding component due to sampling specified by the minimum pixel pitch (e.g., p) does not occur. An under-sampling image may be appropriately generated from the resulting frame image data by data processing. For example, when the number of pixels of each pixel group corresponds to the high-vision resolution (i.e., the total number of pixels of the four pixel groups is four times the high-vision resolution), an image that has a resolution four times the high-vision resolution may be sequentially generated by the interpolation process, and a high-vision image may be generated from the generated image by a down-sampling process. A sequentially generated image that has a resolution four times the high-vision resolution may optionally be used. This prevents a situation in which the resolution does not substantially increase due to a low band limit (e.g., a band limit corresponding to the pitch 2p), even if a plurality of field images are synthesized to generate an image that contains all of the pixels, when generating an image using ¼ of the pixels.

Note that the movement of the object obtained from the imaging signal processing section 120 may be detected irrespective of mode selection. When the object moves quickly, the normal mode may be automatically selected to give priority to high-speed imaging. When the object moves slowly, the high-resolution mode may be automatically selected to give priority to resolution.

Note that the normal mode or the high-resolution mode may not be designated during imaging. Field image data may be generated and stored, and a frame image may not be generated during imaging. In this case, a frame image (high-definition mode image) may be appropriately generated using the stored field image data, and displayed after imaging.

### 12. Electronic Instrument

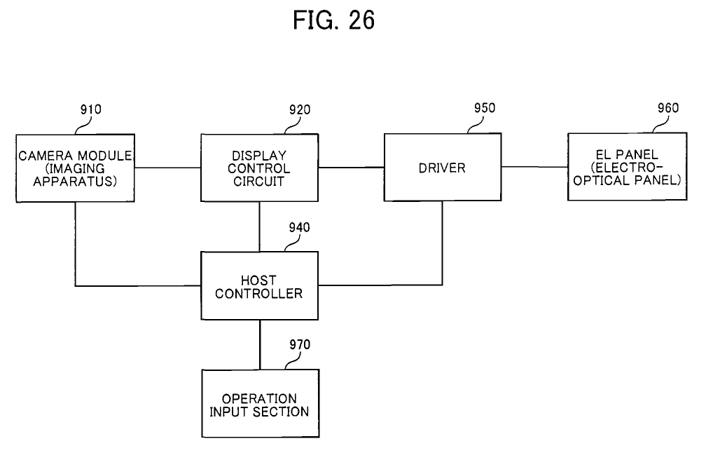

FIG. 26 shows a configuration example of an electronic instrument that includes the imaging apparatus according to one embodiment of the invention. The electronic instrument shown in FIG. 26 includes a camera module 910 (imaging apparatus), a display control circuit 920, a host controller 940, a driver 950 (display driver), and an electro-optical panel 960. Note that various modifications may be made, such as omitting some of the elements or adding other elements.

Examples of the electronic instrument that is implemented by this embodiment include a digital camera, a digital video camera, a portable information terminal, a mobile phone, a portable game terminal, a WEB camera, and the like.

The camera module 910 includes a lens, an image-pickup element, a lens driver section, and the like, and performs a pixel shift operation and an imaging operation. The display control circuit 920 supplies image data supplied from the camera module 910, a horizontal synchronization signal, a vertical synchronization signal, etc. to the driver 950. The host controller 940 is a CPU, for example. The host controller 940 receives operation information from an operation input section 970, and controls the camera module 910, the display control circuit 920, and the driver 950. The electro-optical panel 960 is a liquid crystal panel or an EL panel, for example. The electro-optical panel 960 is driven by the driver 950, and displays an image. The operation input section 970 allows a user to input information. The operation input section 970 may be implemented by a button, a keyboard, etc.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., lens, image sensor, frame buffer memory, and defocus control) cited with a different term (e.g., imaging optical system, image-pickup element, storage section, and optical filtering process) having a broader meaning or the same meaning at least once in the specification and the drawings can be replaced by the different term in any place in the specification and the drawings. The configurations and the operations of the image processing device, the imaging apparatus, the electronic instrument, etc. are not limited to those described in connection with the above embodiments. Various modifications and variations may be made.

1. An imaging apparatus comprising:
an image-pickup element;
an imaging optical system that forms an image of an object in the image-pickup element;
a pixel shift control section that causes the image of the object formed in the image-pickup element to be shifted by a shift amount s, and then sampled;
a storage section that stores a plurality of field images, each of the plurality of field images being obtained by each of imaging operations, each of imaging operations being performed by the image-pickup element while the image of the object is shifted by the shift amount s; and
an image generation section that generates a frame image based on the plurality of field images, and sequentially outputs the generated frame image every field.

2. The imaging apparatus as defined in claim 1,
the pixel shift control section performing a shift operation a plurality of times per cycle, the shift operation shifting the image of the object by the shift amount s; and
the image generation section sequentially outputting the generated frame image every field that is shorter than the cycle.

3. The imaging apparatus as defined in claim 1, further comprising:
an optical filtering section that performs an optical filtering process that adjust an upper limit of a spatial frequency band of the image of the object formed in the image-pickup element to a frequency fm; and
a band-limiting section that band-limits the frame image by a cut-off frequency fc,
fc≦fm≦1/2s being satisfied.

4. The imaging apparatus as defined in claim 3,
the optical filtering section performing the optical filtering process by focus control.

5. The imaging apparatus as defined in claim 3, further comprising:
an optical low-pass filter that band-limits the spatial frequency of the image of the object by a cut-off frequency fo; and
an aperture mask, a length of one side of a pixel aperture of the aperture mask being a,
a≦s≦p and fm≦fo being satisfied when a pixel pitch of the image-pickup element is p.

6. The imaging apparatus as defined in claim 1,
the image generation section generating the frame image by synthesizing a kth field image with (k−(n−1))th to (k−1)th field images wherein k and n are natural numbers,
the kth field image being obtained by a current imaging operation performed by the image-pickup element,
the (k−(n−1))th to (k−1)th field images being obtained by preceding (k−(n−1))th to (k−1)th imaging operations performed by the image-pickup element.

7. The imaging apparatus as defined in claim 1,
the image generation section generating a pixel value of a pixel of an mth frame image by performing a temporal interpolation process using a pixel value that corresponds to the pixel of a first field image and a pixel value that corresponds to the pixel of an nth field image wherein m and n are natural numbers,
the pixel value that corresponds to the pixel of the first field image being obtained by a first imaging operation performed by the image-pickup element before an mth imaging operation,
the pixel value that corresponds to the pixel of the nth field image being obtained by an nth imaging operation performed by the image-pickup element after the mth imaging operation.

8. The imaging apparatus as defined in claim 1,
the pixel shift control section performing a shift operation during zoom imaging while reducing the shift amount s.

9. An imaging apparatus comprising:
a compound imaging unit that includes a plurality of image-pickup elements, and a plurality of imaging optical systems that form an image of an object in the plurality of image-pickup elements;
a pixel shift control section that causes the image of the object formed in each of the plurality of image-pickup elements to be shifted by a shift amount s, and then sampled;
a storage section that stores a plurality of field images, each of the plurality of field images being obtained by each of imaging operations, each of imaging operations being performed by the image-pickup element while the image of the object is shifted by the shift amount s; and
an image generation section that generates a frame image based on the plurality of field images, and sequentially outputs the generated frame image every field.

10. An imaging apparatus comprising:
an image-pickup element that includes first to rth pixel groups that are formed to sample an image of an object at a pitch of p wherein r is a natural number;
an imaging optical system that forms the image of the object in the image-pickup element;
an imaging control section that controls imaging of the image-pickup element so that an image is sequentially acquired every field using each of the pixel groups;
a storage section that stores a plurality of field images, each of the plurality of field images being obtained by imaging using each of the pixel groups; and
an image generation section that generates a frame image based on the plurality of field images, and sequentially outputs the generated frame image every field.

11. An electronic instrument comprising the imaging apparatus as defined in claim 1.

12. An image processing device comprising:
a pixel shift control section that causes an image of an object formed in an image-pickup element to be shifted by a shift amount s, and then sampled;
a storage section that stores a plurality of field images, each of the plurality of field images being obtained by each of imaging operations, each of imaging operations being performed by the image-pickup element while the image of the object is shifted by the shift amount s; and
an image generation section that generates a frame image based on the plurality of field images, and sequentially outputs the generated frame image every field.

13. An image processing method comprising:
causing an image of an object formed in an image-pickup element to be shifted by a shift amount s, and then sampled;
storing a plurality of field images, each of the plurality of field images being obtained by each of imaging operations, each of imaging operations being performed by the image-pickup element while the image of the object is shifted by the shift amount s and
generating a frame image based on the plurality of field images, and sequentially outputting the generated frame image every field.
